(19) United States
(12) Patent Application Publication
(10) Pub. No.: US 2004/0224559 A1
(43) Pub. Date: Nov. 11, 2004

(54) High-density connector assembly with tracking ground structure

(76) Inventors: Richard A. Nelson, Geneva, IL (US); Daniel B. McGowan, Naperville, IL (US); Galen F. Fromm, North Aurora, IL (US); Brian P. O'Malley, Naperville, IL (US)

Correspondence Address: Thomas D. Paulius, MOLEX INCORPORATED, 2222 Wellington Court, Lisle, IL, 60532, US

(21) Appl. No.: 10/728,175

(22) Filed: Dec. 4, 2003

Related U.S. Application Data
(60) Provisional application No. 60/430,775, filed on Dec. 4, 2002.

(51) Int. Cl. H01R 13/648

(52) U.S. Cl. 439/608

(57) ABSTRACT

A connector assembly is suitable for connecting circuit boards together. The connector assembly includes a series of ground and signal terminal sets assembled in terminal assemblies held within a housing. The ground terminals sets include a set of flat contact blades that are aligned together in abutting contact to form a line of ground contacts blades and the signal terminals are arranged in sets on opposite sides of the ground terminal contact blades. The signal terminals have general L-shapes that are arranged in sets of two pairs of contacts to form a cruciform pattern with an associated ground contact blade in the midst of the pattern of four. The terminal assemblies are formed from housings that have interfitting projections on their exterior sides, and the ground terminal housing is plated with a conductive material. This effectively surrounds each signal terminal in its extent through the signal terminal housing.

### REFERENCE TO RELATED APPLICATION

This application claims priority of prior U.S. provisional patent application Ser. No. 60/430,775, filed Dec. 4, 2002.

### BACKGROUND OF THE INVENTION

The present invention relates generally to high density connectors and, more particularly, to high density connectors that are used to connect two printed circuit boards together in an orthogonal arrangement. High density interconnect systems are used in numerous data communication applications, and one such application is in network servers and routers. In many of these applications, the interconnect systems include male and female connectors that are mounted to different circuit boards, such as in the manner of conventional right-angle connectors, in which the two circuit boards are oriented at 90° with respect to each other so that two edges of the circuit boards abut each other. High density connectors typically use pin and box terminal or blade to blade terminal mating arrangements. With these high-density structures, it is desired to provide complete shielding of the signal terminals to the extent possible from the connector terminal tail portions to the connector terminal contact portions.

In high-density connectors that utilize wafer-style construction, it is difficult to provide full shielding to the signal terminals, whether the terminals are intended to carry either single signals or differential signals, as they extend through the wafer body or as they traverse a path from a mounting end of the connector assembly to the mating end thereon. Shielding is known to be provided in the prior art by using intersecting plates in the forward part of the mating area, and in some instances, forming complex shield members that have portions bent at right angles thereto which extend out of the plane of the ground member to provide one or more shielding walls. Isolating the signal terminals electrically involves positioning ground shields close to the signal terminals and this increase the structural complexity of the connector and its constituent wafers, or terminal assemblies. It is not always possible to bend and form a metal shielding plate in a configuration so as to completely encompass an associated signal terminal within the wafer. If the shield were to encompass the signal terminal, high speed signal transmission speeds would be obtainable with minimal crosstalk and electrical noise.

A need therefore exists for a high density interconnection system that has more complete shielding of the signal terminals throughout the connector.

### SUMMARY OF THE INVENTION

The present invention is directed to an improved high-density interconnection assembly that overcomes the aforementioned disadvantages.

Accordingly, it is a general object of the present invention to provide a connector assembly wherein at least one of the connectors is formed from a plurality of individual terminal subassemblies, preferably in the form of wafers, that are arranged in an alternating fashion with respect to the connector terminals such that every grounding member is flanked on opposing sides thereof by an associated signal wafer.

Another object of the present invention is to provide a high-density connector assembly for use in high-speed applications, the connector assembly being assembled from a plurality of terminal assemblies, each terminal assembly including a first set of signal terminals, a second set of signal terminals and a set of ground terminals associated therewith, the first and second set of signal terminals being supported by insulative housings, the set of ground terminals being associated with a ground structure that includes a support body that having a plurality of channels formed therein, the support body having a plurality of signal terminal-receiving recesses formed therein and the support body being covered with a conductive material, such as a metal plating or coating, whereby the support body provides shielding to the ground structure throughout the terminal assembly

A still further object of the present invention is provide a header assembly for use in high-speed applications, the header assembly including a header base having at least one hollow receptacle formed therein, a plurality of terminal assemblies, the assemblies each including a plurality of signal terminals and ground terminals arranged in a ground-signal-ground terminal order, some of the terminal sets being signal terminals and being supported by insulative bodies, the bodies being flanked, as are their associated terminals, by sets of ground terminals, each of the ground terminal sets including an elongated base portion and a plurality of contact and tail portions extending therefrom on opposite sides thereof.

Another object of the present invention is to provide a high density connector that has a plurality of conductive terminals supported on an insulative housing and wherein the terminals are separated into distinct sets of signal and ground terminals, the ground terminals having the form of double, flat blades that project forwardly of the connector body and the signal terminals having contact portion with general L-shapes, the signal terminal being arranged on opposite sides of the ground blades in a cruciform pattern.

A still further object of the present invention is to provide a connector for mating with the high density connector described above wherein the signal terminal of this connector include contact portions which are also L-shaped and which include a pair of contact arms that extend in different planes from an L-shaped body portion of the terminals.

Yet another object of the present invention is to provide a high-density, high-speed connector structure which utilizes a double ground to provide both ground reference to signal terminals and isolation between rows of signal terminals.

Still yet another object of the present invention is to provide a high-density, high-speed connector suitable for interconnecting two circuit boards together, the connector including distinct sets of terminal assemblies held within a housing, the terminal assemblies including a plurality of tail portions for connecting the terminals to a circuit board and a plurality of contact portions for contacting terminals of a mating connector, each of the distinct terminal sets including a central ground structure having a central conductive ground plate with a plurality of contact portions extending therefrom, the central ground plate being encapsulated within a dielectric shell, the shell having a conductive coating disposed on its exterior surfaces which contacts the central ground plate, each distinct terminal set further including a plurality of signal terminals arranged in two arrays, each signal terminal including a tail portion for connecting to a circuit board and a contact portion for connecting to the mating connector, and a body portion that interconnects the signal terminal tail and contact portions together, each of signal arrays being held within a dielectric shell, the signal terminal shells being disposed on opposite sides of the ground structure, each signal terminal shell including a plurality of raised lands that encapsulate the signal terminal body portions, and the central ground structure including a plurality of channels, each of which receives a single raised land of an opposing signal terminal shell, the terminal assembly further including a pair of ground plates disposed on exterior surfaces of the signal terminal shells and spaced apart from the central ground structure and signal terminals, whereby each signal terminal body portion is partially enclosed within by a reference ground.

The present invention accomplishes the aforementioned and other objects by way of its novel and unique structure. In this regard, the header portion of the connector assembly includes an insulative body having a plurality of sidewalls that define one or more hollow receptacles. An array of conductive terminals are maintained within the header receptacles and multiple arrays are arranged to form a single terminal assembly. Each such assembly preferably includes a central ground member having a base and a plurality of contact blades extending therefrom in spaced-apart order. The contact blades are flanked by a pair of signal terminal sets, each of the terminal sets including an insulative base and a plurality of contact portions extending therefrom and flanking the contact blades. An additional set of ground terminals is provided on the opposite side of one of the signal terminal sets, and this ground terminal also has a base portion with a plurality of contact blades extending therefrom.

The terminal sets of these receptacle connectors have a plurality of tail portions arranged thereon and these tail portions may take the form of surface mount tails, solder ball tails, compliant pins and the like. The signal terminals are preferably formed as L-shaped contacts and four such contacts flank each ground contact blade. The terminal sets are arranged in a fashion within each such header receptacle so that they define rows of terminals in a ground-signal-ground-signal order within each terminal assembly, and a final ground terminal set is assembled to the group of terminals to end the overall order of the terminals with a ground. In this manner, an overall low profile set of terminals is defined with columns of the terminals being arranged so that four of the signal terminals define a cruciform pattern about each of the associated ground contact blades.

An opposing plug connector of the connector assembly of the present invention is provided with a plurality of terminal assemblies that are held within a housing. Each terminal assembly is constructed so that it may be individually inserted or removed from the housing, permitting repair and replacement of the same rather than replacement of the entire plug connector. Each terminal assembly is formed from a plurality of terminal arrays, with some of the arrays being mounted on insulative bodies, preferably taking the form of wafers or shells. Each such terminal assembly preferably includes a pair of insulative signal terminal shells, each of which supports a plurality of conductive signal terminals, particularly the body portions of the terminals that interconnect contact and tail portions that extend out from the signal terminal shells along distinct sides thereof.

The contact portions of the signal terminals each have a pair of contact arms that are interconnected by a base, and the contact arms define an L-shaped orientation that will slidingly engage the L-shaped contacts of the header connector. This manner on engagement places a signal terminal at four corners in an imaginary box that can be scribed around each center ground contact blade.

The terminal assemblies each further include a central ground structure that supports a ground plate having a plurality of ground terminals with tail and contact portions that extend from the flat body of the ground plate. Each ground terminal contact portion includes a pair of contact arms. In this manner, the ground contacts of the header connector and the plug connector will engage each other transversely, taking the form of a grounding cross pattern that extends through the mating region of the two connectors. Thus, in the mating regions of the two connectors, a cross pattern is formed between engaging ground contact blades.

In an important aspect of the present invention, the terminal assemblies of the plug connectors include one or more dielectric inserts that may be conductively plated on their exterior surfaces. These inserts preferably take the form of shells, that house terminals. Each such signal terminal shell has a plurality of channels and raised lands formed therein and each land encompasses a single signal terminal, typically the body portion thereof, therein. The conductive plating may be provided thereon to define a shield that partially encompasses the signal terminals.

In the preferred embodiment of the invention, the central ground structure includes a dielectric shell that partially encapsulates the central ground plate, leaving the contact and tail portions thereof exposed. The exterior surfaces of this dielectric shell is coated with a conductive substance, such as a metal plating, and this coating contacts the central ground plate so that the entire ground structure will act electrically as a single ground member in this embodiment. This plated dielectric shell has a plurality of channels formed therein which are defined by spaced-apart raised lands. The raised lands of the signal terminal shells fit are received within the channels of the central ground structure on opposite sides of the central ground structure to form a sandwich-style or layered terminal assembly. Two additional ground terminal arrays are also provided in order to provide a ground reference on the outboard sides of the two signal terminal shells. These two additional ground terminal arrays preferably take the form of solid plates with tail and contact portions extending therefrom and they serve to close off each conductive channels in which a single signal terminal is received. In this fashion, each signal terminal is entirely encompassed by four ground walls so as to electrically isolate it from each other signal terminal, which structure will minimize crosstalk and electrical noise from occurring.

In this regard, and in another principal aspect of the present invention, the receptacle connector includes a plurality of terminal subassemblies that are assembled from at least different parts and preferably four different parts. These parts include two signal terminal sets that flanking a central ground terminal set, and an additional ground terminal set is preferably provided so that the terminal sets may be arranged in a ground-signal-ground-signal terminal set order. A single ground terminal set may be used as an end of the assembly so that throughout the entire assembly, a ground-signal-ground order is maintained. The signal terminals sets are supported on dielectric housings and have tail portions extending from one side of the housing which mate with a circuit board, contact portions that extend from another side of the housing for mating with terminals of an opposing connector and body portions interconnecting the contact and tail portions together and which are supported by the housings.

In order to provide effective shielding to the connector of the assembly and in another principal aspect of the present invention, the inner piece of each shell includes a grounding shield which may be held in a plastic or dielectric frame and in which a plurality of contact blades may be formed. The first and second sets of signal and ground terminals have flat blade portions that are arranged within each connector component so that the first and second sets of ground terminals preferably abut each other and extend in a line down the center of the wafer, and the first and second sets of signal terminals lie on opposite sides of, or “flank”, the first and second sets of ground terminals, the insulative coverings of said first and second sets of signal terminals preventing unintentional shorting from occurring between the signal and ground terminals. The first and second sets of signal terminals are further arranged so that one pair of first signal terminals and one pair of second signal terminals are disposed on opposite sides of one of the contact portions of the first and second sets of ground terminals. In this arrangement, the L-shaped signal terminal contact portions extend in directions that are both parallel and perpendicular to the said ground terminal flat blade portion, whereby, said pairs of first and second signal terminals form a cruciform pattern when viewed from a contact end thereof.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is perspective view of an orthogonal connector assembly constructed in accordance with the principles of the present invention, with the assembly including a plug and receptacle connector mated together;

FIG. 2 is a perspective view of the receptacle connector of the connector assembly of FIG. 1.

FIG. 3A is a side elevational view of the receptacle connector of FIG. 2; FIG. 3B is a bottom plan view of the receptacle connector of FIG. 2 with the circuit board removed;

FIG. 4 is a perspective view of the plug connector of the connector assembly of FIG. 1;

FIG. 5 is a side elevational view of the plug connector of FIG. 4;

FIG. 6 is an exploded perspective view of the receptacle connector of FIG. 2;

FIG. 7 is a perspective view of a signal terminal wafer used in the receptacle connector of FIG. 6;

FIG. 8 is a perspective view of the signal terminal wafer of FIG. 7 assembled to a ground terminal wafer;

FIG. 9 is an exploded view of one of the receptacle connector tri-wafers;

FIG. 10 is an exploded view of one of the plug connector tri-wafers;

FIG. 11 is a sectional view taken through the receptacle connector of FIG. 2 illustrating the mating portion fully flexed in the upward extent of the “Y” direction;

FIG. 12 is a view similar to FIG. 11, but illustrating the mating portion fully flexed in the downward extent of the “Y” direction;

FIG. 13 is an enlarged detail view of the lower part of the flexural section of the receptacle connector;

FIG. 14 is a sectional view taken horizontally through the receptacle connector and illustrating the full flexure of the mating portion in one way (direction) of the “X” direction;

FIG. 15 is the same view as FIG. 14, but illustrating the full flexure of the connector in the opposite (rightward) direction;

FIG. 16 is a perspective view of an alternate embodiment of a receptacle connector constructed in accordance principles of the present invention and which incorporates power terminals;

FIG. 17 is a perspective view of an alternate embodiment of a plug connector that mates with the receptacle connector of FIG. 16;

FIG. 18 is a perspective view of a power terminal set lead frame used in the receptacle connector of FIG. 15.

FIG. 19 is a perspective view of the power terminal lead frame with its frame molded onto it;

FIG. 20 is a perspective view of the power signal/ground terminal set lead frame used in the plug connector of FIG. 17;

FIG. 21 is a perspective view of the lead frame of FIG. 20 assembled into a plug connector tri-wafer;

FIG. 22 is a side elevational detail view of the manner of engagement between the grounding shield contact portions of the plug and receptacle connectors of the connector assembly of FIG. 1;

FIG. 23 is an enlarged detail perspective view illustrating the manner of engagement between the grounding shield contact portions of the plug and receptacle connectors of the connector assembly of FIG. 1;

FIG. 23A is a schematic view of the contact area of FIG. 23, with the two connectors joined together;

FIG. 24 is a perspective view of a pair of opposing connector wafers constructed in accordance with the principles of an alternate embodiment of the present invention and shown mated together;

FIG. 24A is an enlarged detail view of the mating which occurs between the two connector wafers of FIG. 24;

FIG. 25 is a perspective view of the rightmost wafer assembly of FIG. 24;

FIG. 26 is a top plan view of the wafer assembly of FIG. 25;

FIG. 27 is a top plan view of the leftmost wafer assembly of FIG. 24;

FIG. 28 is an enlarged detail view of the signal and ground terminal contact portions of the wafer assembly of FIG. 25, with its associated support bar removed for clarity;

FIG. 29 is a bottom plan view of the wafer assembly of FIG. 26;

FIG. 30 is an enlarged detail view of the front, or contact, end of the wafer assembly of FIG. 29, taken along lines 30-30 thereof;

FIG. 31 is a front elevational view of the wafer assembly of FIG. 26;

FIG. 32is an enlarged detail view of a portion of FIG. 31;

FIG. 33 is an enlarged detail view of the wafer assembly of FIG. 25, illustrating the sandwich-style layered structure thereof;

FIG. 34 is a front elevational view of the wafer assembly of FIG. 27;

FIG. 35 is an enlarged detail view of the top portion of FIG. 34;

FIG. 36 is bottom plan view of the wafer assembly of FIG. 34;

FIG. 37 is an enlarged detail view of the front end of FIG. 36;

FIG. 38 is an enlarged detail view (in perspective) of the wafer assembly of FIG. 27;

FIG. 39 is a perspective view illustrating the terminal assemblies of FIG. 27 engaged together in an orthogonal connection with one of the terminal assemblies having an alternate flexing portion construction;

FIG. 40 is an elevational view of a connector assembly constructed in accordance with the principles of the present invention and mated together;

FIG. 41 is a perspective view of the header connector of the assembly of FIG. 40;

FIG. 42 is an enlarged partial detail view of a portion of the header connector of FIG. 41;

FIG. 43 is an exploded perspective view of FIG. 42;

FIG. 44 is a perspective view of a terminal arrangement provided within one of the receptacles of the header connector of FIG. 41;

FIG. 45 is an exploded view of one of the terminal assemblies that make up the terminal arrangement of FIG. 45;

FIG. 46 is an enlarged partial detail view of the plug connector of the connector assembly of FIG. 40;

FIG. 46A is the same view as FIG. 46, but with the connector cover removed and two terminal assemblies in the connector housing, with one of the terminal assemblies being slightly withdrawn to illustrate the manner in which the assembly engages the housing;

FIG. 47 is an exploded view of one of the multiple terminal assemblies used in one of the components of the plug connector of FIG. 46;

FIG. 47A is a perspective view of the terminal assembly of FIG. 47 in an assembled state;

FIG. 48 is the same view as FIG. 47, but illustrating only the two signal terminal elements and the central ground terminal element that interengages the signal terminal elements;

FIG. 48A is an exploded view illustrating the central ground plate removed from its support structure;

FIG. 49 is an exploded view of one signal terminal housing and a signal terminal set supported thereby;

FIG. 49A is an isolated view of the leftmost signal terminal support member in FIG. 47 with the front part of the housing removed along lines A-A of FIG. 47;

FIG. 50 is a signal terminal lead frame prior to separation of the individual terminals and prior to supporting in an insulative terminal housing;

FIG. 51 is an exploded view of a ground terminal component used in the plug connector of FIG. 46;

FIG. 51A is the same view as FIG. 51, with the elements shown in an assembled state;

FIG. 52 is a sectional view of the ground terminal component in an assembled state, and taken along the line 52-52 of FIG. 51;

FIG. 53 is a plan view of the sectional line of FIG. 52;

FIG. 54 is an enlarged detail sectional view of a plug connector terminal assembly;

FIG. 55 is an enlarged detail view of the terminal contact portions of a plug connector terminal assembly; and,

FIG. 56 is an enlarged detail view of the terminal tail portions of a plug connector terminal assembly illustrating the use of solder balls with the tail portions thereof.

### DETAILED DESCRIPTION OF THE PREFERRED EMBODIMENTS

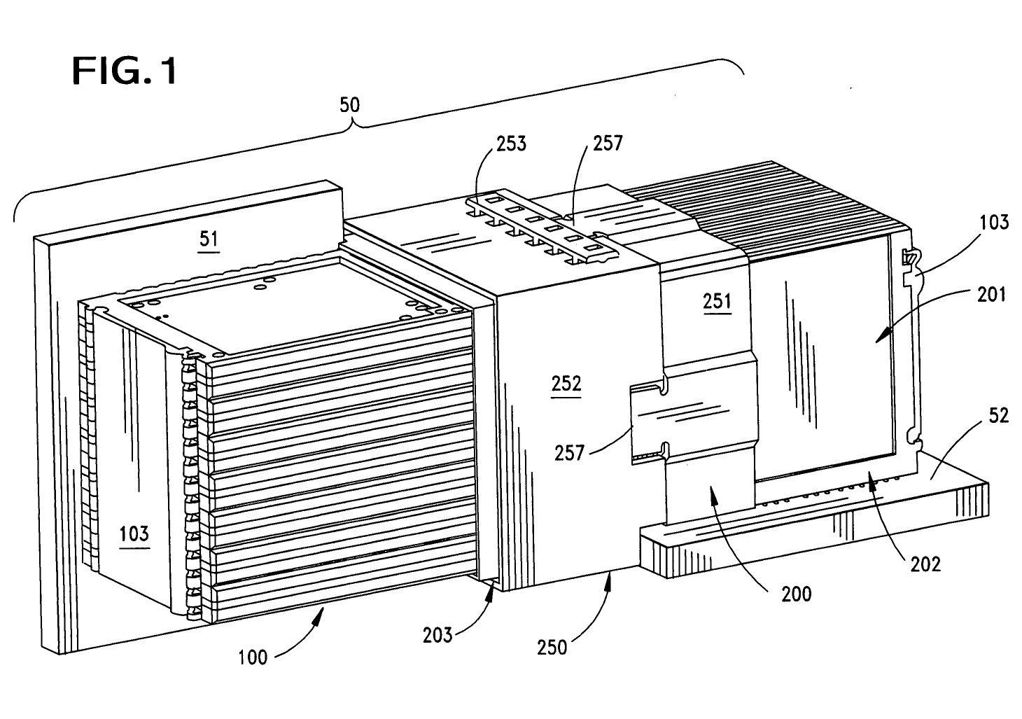

FIG. 1 illustrates a connector assembly 50 used for connecting two circuit boards 51, 52 together in an orthogonal orientation, with portions of the circuit boards 51, 52 are shown for clarity. In practice, the horizontal circuit board 52 may have a greater extent in the horizontal plane (into and out of the paper as shown) and may include a plurality of connector assemblies 50 so as to mate with a plurality of vertical circuit boards 51.

The connector assembly 50 illustrated has a structure that permits flexing to occur between the two connectors 100, 200 that are respectively mounted to the circuit boards 51, 52. One of the connectors is a “plug” connector and the other is a “receptacle” connector. It will be understood that in this description, the connector 100 is termed the plug connector because it is received within the receptacle connector 200.

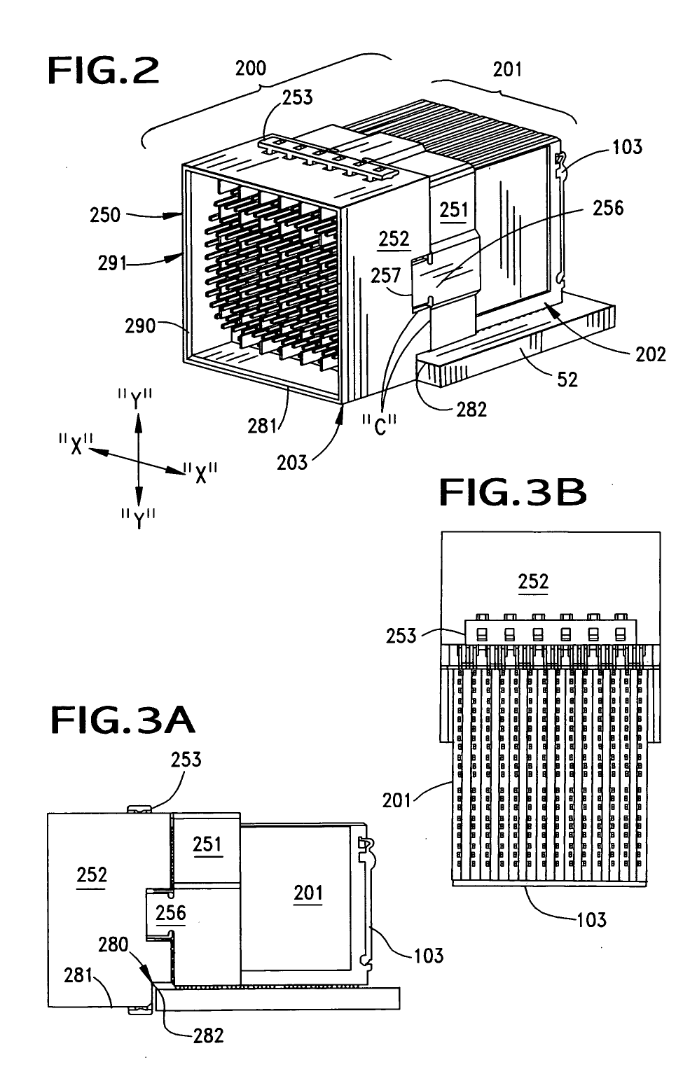

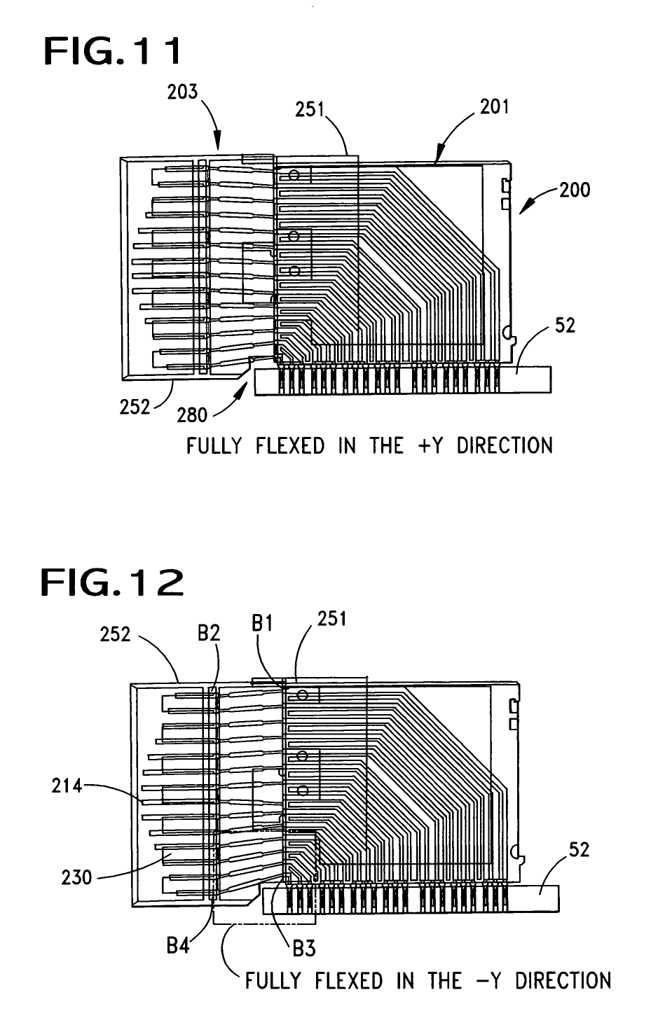

FIGS. 2-3B illustrate the receptacle connector 200. This connector 200 can be seen to have a body portion 201, a mounting portion 202 that mounts to the circuit board 52 and a mating portion 203 that extends out from the body portion 201 to mate with a like mating portion of the plug connector 100. The mating portion 203 of the connector 200 can move a preselected distance in any one of four directions with in two distinct horizontal and vertical planes, shown in FIG. 2 at the left and the “Y” direction for upward movement, “−Y” direction for downward movement, “X” for leftward movement and “−X” for rightward movement. The extent of this flexure is shown in detail in FIGS. 11-15. Although in the course of this description, the movement of the connectors of the invention will be described in linear terms with respect to the preferred embodiment, i.e. in the common directions of up/down and left/right, it will be understood that the flexural properties of connectors of the invention are not limited only to these four directions, but include radial, diagonal and other directions. Also, it will be understood that although the flexing movement is described only in terms of the receptacle connector, the principles of the invention may be employed to form flexing portions on plug connectors.

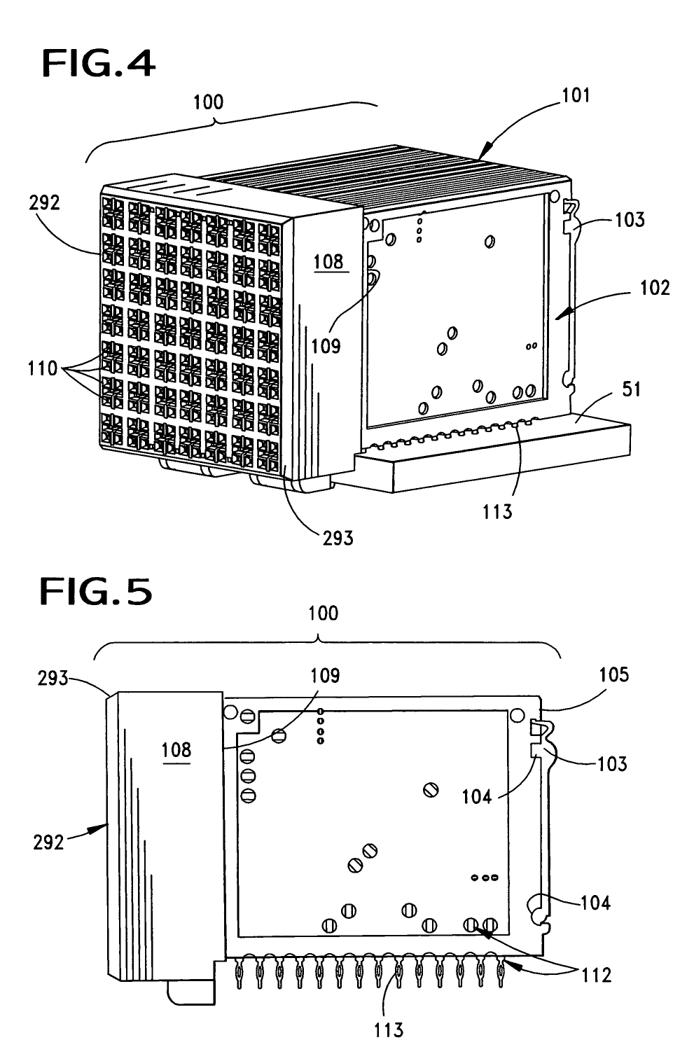

The plug connector 100 (FIG. 4) is preferably constructed so it is fixed with respect to the circuit board 51, and it includes a cover portion 108 that is received within the opening of the shroud of the receptacle connector 200. The plug connector 100 is formed from a series of components 101 that are referred to herein as “wafers” because of their relatively thin configuration. These wafers 101 are assembled into a stack, or block 102 of wafers, which are maintained together as a unit by an aligner, or retainer 103, that engages a series of recesses 104 formed in the rear face 105 of the connector block 102. A cover member 108 is also preferably provided to fit over the front, or mating face 109, of the connector block 102 and may have a series of openings 110 formed therein that are aligned with terminal mating, or contact portions (not shown) of the plug connector 100. The terminals 112 of the plug connector 100 may terminate in tail portions, such as the through-hole compliant pins 113 shown, that are received within corresponding mounting holes or vias formed in the circuit board 51. Other means of mounting are also contemplated, such as surface mounting, ball grid arrays, etc.

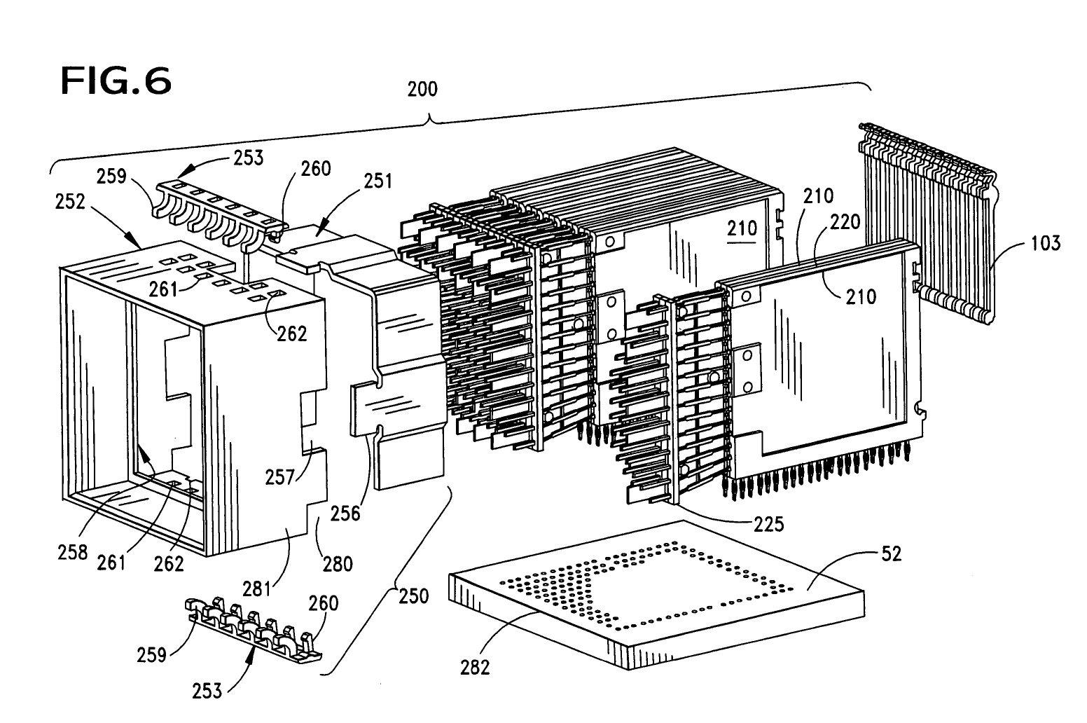

The wafers of this connector are preferably assembled together in groups of three in order to effect single-ended signal transmission and in the order of S-ES (signal-ground-signal) which means that a ground wafer or member is provided between every two signal wafers. When the wafers are assembled in their tri-wafer fashion (as illustrated in FIGS. 6, 9, 10 and 21) they may be removed and replaced as a tri-wafer, or a single terminal assembly, which facilitates the maintenance and repair aspects of connectors of the present invention.

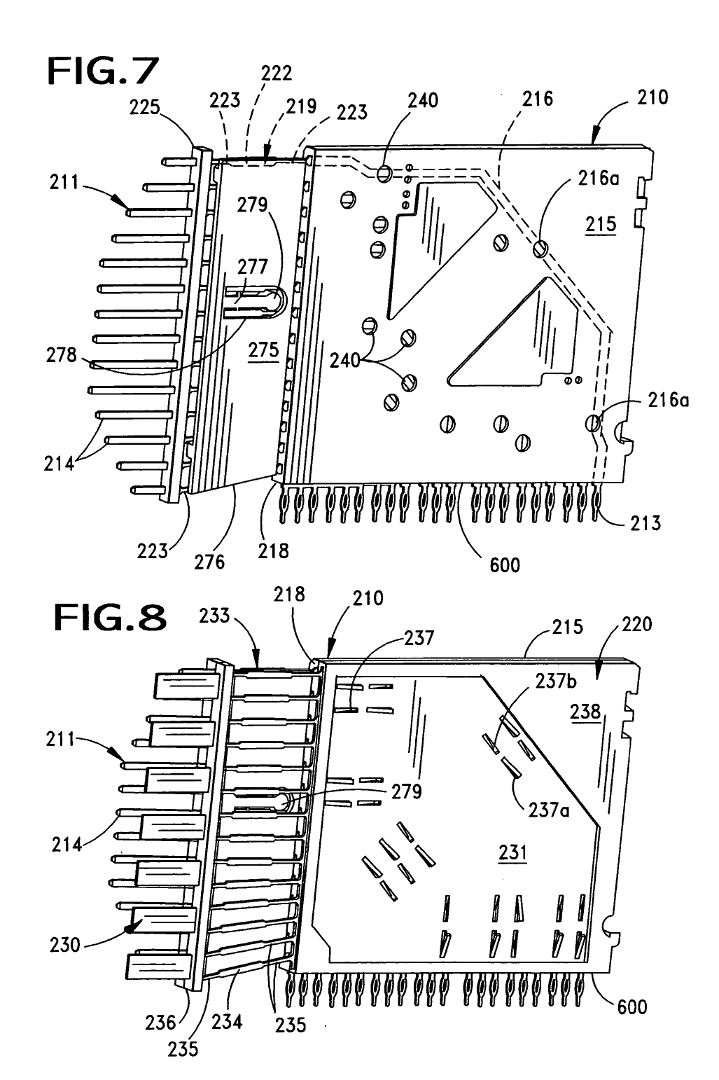

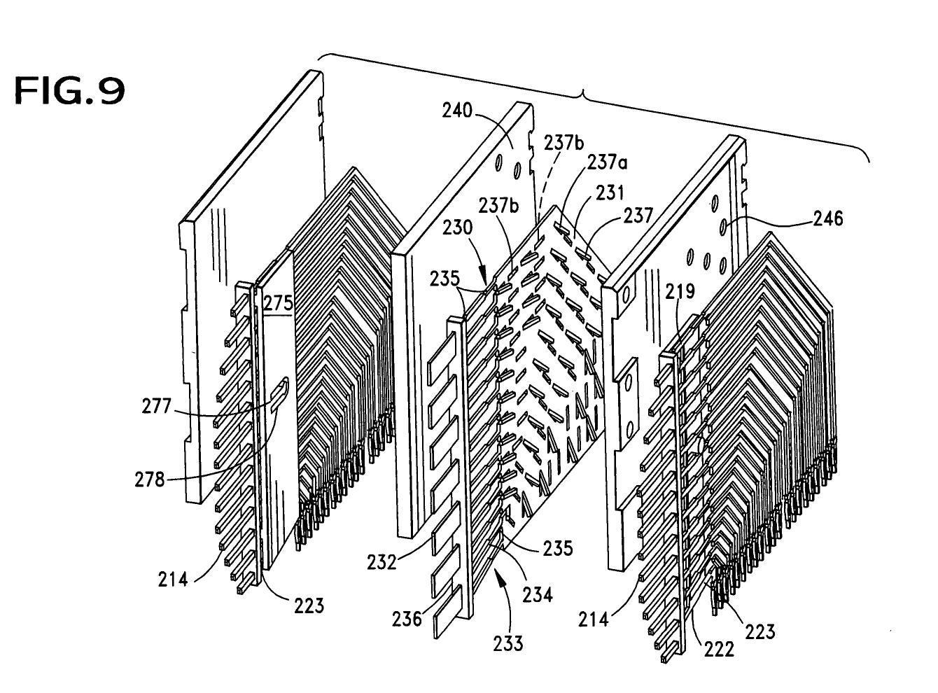

Turning now to FIGS. 7 and 8, two wafers 210, 220 of the receptacle connector 200 are illustrated. In FIG. 7, a signal terminal wafer 210 is shown, while in FIG. 8, a signal and ground wafer are shown aligned together in an adjoining relationship. It will be understood that an additional signal wafer 210 is missing from the side of the ground wafer 220 that is exposed to view in FIG. 8 and that the terminal assembly of this embodiment on the invention includes two signal terminal wafers on opposite sides of a central ground terminal wafer, as shown exploded in FIG. 9.

The signal terminal wafer 210 supports a terminal set 211 that is termed herein as “signal” terminal set in that it includes terminals that are intended to carry electrical signals and ground reference signals, but it does not include a structure that is intended to act entirely as a ground, such as a grounding shield. The terminals 211 may be stamped and formed into a lead frame and then a housing portion 215 preferably of an insulative and/or dielectric material, is formed about them such as by insert molding, overmolding or other suitable technique. Each terminal has a tail portion 213 for mounting to a circuit board 52 and a contact portion 214 that also projects from one edge, or face 218, of the housing (or wafer) 215 for mating with an opposing contact of the plug connector 100. The tail portions 213 also project along another edge, or face, 600 of the housing 215. These two tail and contact portions are interconnected by intervening terminal body portions 216 (shown in phantom in FIG. 7), which define an electrical path through the terminals between the contact portions 214 and the tail portions 213.

Parts of the terminals in the mating region thereof that protrude past the front face 218 of the connector wafers/housings 215 may be considered as defining flexing or flexural portions 219 that are interposed between the contact portions 214 and the terminal body portions 216 or the wafer front face 218. As seen in FIGS. 2, 8 and 9, this flexing portion 219 includes a central body 222 that has a thickness and width that approximates that of the terminal body portion 211. This body 222 is flanked by two thin necks, or flex arms 223, that have a vertical width (or thickness) less than that of the terminal contact, center body or body portions (214, 222, 216). This reduction in size increases the resiliency of the flexing portion 219, while the thicker body portion 222 provides strength and also affects the electrical characteristics of the terminals through the flexing portions. It increase capacitive coupling between the signal and ground terminal flexing portions which will result in a decrease in impedance in this area of the connector. It also increases electrical isolation of the signal terminals on opposing sides of the arrays of ground terminals. The sizes of the bodies of the flexing portions may then be dimensioned so as to achieve a desired impedance level within this portion of the connector.

The flexing portions are not limited to the structure shown in FIGS. 1-15, but may take other forms. FIG. 39 illustrates two opposing terminal assemblies, and in which one of the assemblies 900, has an alternate flexing portion construction. The terminal assembly 900 has a plurality of conductive signal terminals 902, 904 and ground terminals 905 supported by an insulative housing 901. The ground terminals 905 are formed by adjoining ground members which are flanked by signal terminals 902 and 904. The terminals have distinct flexing portions 906, 907 that are separated from the contact portions by an elongated support bar 910 that extends over the terminals. Whereas the majority of the flexing portions 906 are straight and linear, the bottom two flexing portions 907 are shown as arcuate in shape. This is to substantially reduce undesired levels of tension or compression forming in the flexing portions, particularly the lowermost flexing portions, during movement of the connector.

A terminal support member 225, shown as an elongated vertical bar, may be molded onto and over part of the terminal contact portions 214 and its purpose will be explained in greater detail below. As used herein, the terms “mating portions” or “mating regions” refer to the terminal portions that project forward from the front face 218 of the connector wafers, or housings 210, 220. Both the contact and flexing portions of the terminals lie in this mating region, or portion.

The ground wafer 220 (FIG. 8) is constructed in a similar fashion and preferably includes a grounding member 230 that is held or supported by a dielectric or plastic frame 238. As shown in this embodiment, the ground member has contact portions 232, but no tail portions. It relies upon its grounding tabs 237 making contact with designated ground terminals in the signal terminal array that have their own tail portions for connection to the circuit board.

This ground member 230 includes a flat plate or body portion 231 which has terminal contact portions 232 projecting forwardly therefrom. These terminal contact portions 232 are connected to the plate body 231 by intervening flexing portions 233 similar in construction to the signal terminal set flexing portions 219 (FIG. 7), and also include a thick central body 234 that is flanked by two thinner flex arms 235. A vertical support bar 236 may also be provided to hold the ground member contact portions 232 in place in the mating region.

In order to provide effective grounding in the overall connector system, the grounding plate 231 is punched, or stamped, to form a plurality of ground tabs 237 that project out from the plate 231. These tabs 237 are preferably located in alignment with specific terminals of the signal terminal set that are designated for carrying ground reference signals, and they project on opposite sides of the grounding plate 231, and as best seen in FIGS. 9 & 10, these grounding tabs extend out from the plane in which the grounding plate 231 extends. The tabs that project to the left of the plate in FIGS. 8 and 9 are designated 237a, while the tabs that project to the right of the plate are designated in these figures as 237b.

As shown in FIG. 8, the ground terminal set is held in a plastic frame 238 that extends around the perimeter of the plate 231. In order to provide contact with specific terminals of the signal terminal set 211, the frame 215 of the signal wafer is perforated, having openings 240 formed therein. These openings 240 are registered with the terminal body portions 216 so that portions thereof 216a are exposed in the openings 240. The grounding tabs 237 of the grounding plate 231 will extend into these openings 240 and contact the exposed terminal body portions 216a. As shown in the drawings, these grounding tabs are arranged in a pattern so that they follow the extent of the ground reference terminals in the signal terminal sets through the insulative housings that support the terminal sets. In this manner, the center grounding plate 231 of each tri-wafer acts as an interstitial ground that is “sandwiched” between two signal wafers. With the structure of the signal terminals, such terminals may be arranged in an alternating vertical order of G-S-G-S-G, where the ground reference terminals will flank (vertically) the signal terminals. The terminals of each terminal assembly may then be easily arranged in horizontal row patterns of S-G-S (in rows of “true” signal terminals), and in horizontal row patterns of G-G-G (in rows where the signal terminals are ground reference terminals).

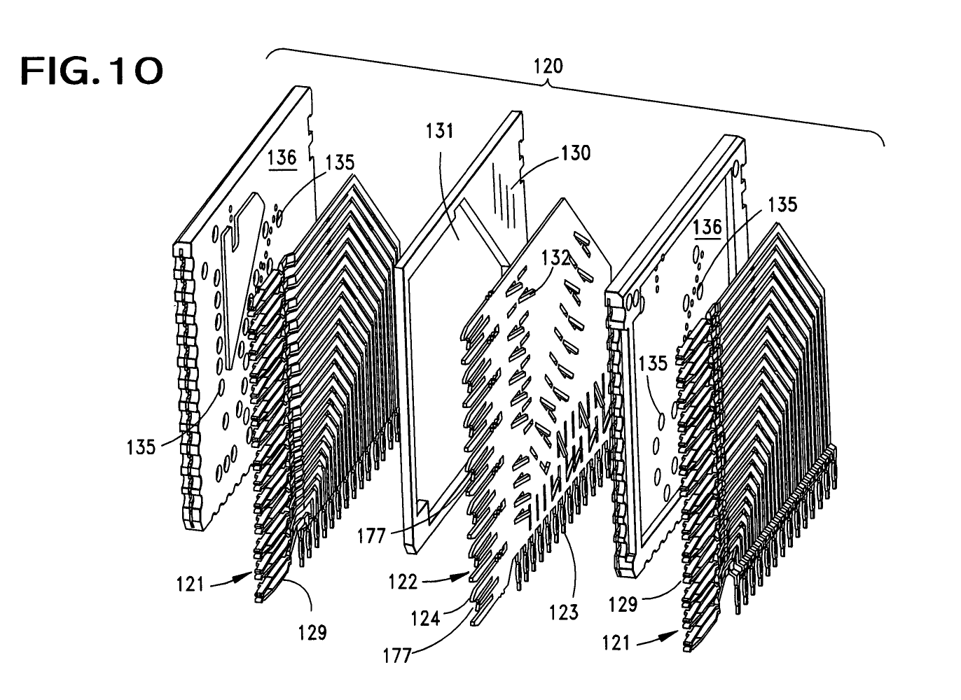

FIG. 10 illustrates a tri-wafer terminal assembly 120 of a different construction which are used in the plug connector 100. In this tri-wafer terminal assembly 120, two signal terminal sets 121 and one ground shield 122 are utilized. The ground shield 122 is interposed between the two signal terminal sets 121 and may include compliant pins 123 and slotted tabs 124 as respective tail and contact portions. The ground shield 122 is held in its own dielectric frame 130 that has a central opening 131 through which its grounding tabs 132 project into contact with designated terminals of the signal terminal sets 121 through openings 135 formed in the dielectric wafers 136 that are molded onto the lead frames of the signal terminal sets 121. The contact portions 129 of the signal terminal sets 121 shown in FIG. 10 are female terminals that receive the pin-style contact portions 214 of the receptacle connector terminals. Likewise, the grounding shield contact portions 124 receive the thick blade contacts of the grounding shield 230 in the slots 177 formed between their contact arms.

Returning now to FIG. 2, the receptacle connector also preferably includes a cover assembly 250, part of which moves with the terminal contact portions as a unit. This cover assembly 250 includes a clamp member 251, shroud 252 and key(s) 253. The clamp member 251 may have an inverted U-shape as shown and is affixed to the block of connector wafers. It does not move, and it assists the wafer aligner 103 in maintaining the connector block as a unit. The clamp member 251 may include legs 256 that project outwardly therefrom and which are used to limit the travel of the shroud 252 on the connector body 201.

The shroud 252 has a hollow square shape as illustrated in FIG. 6 and it has recesses 259 that are complementary to the clamp member legs 256, with two such recesses being illustrated. It also preferably contains an inner shoulder, or ridge 258 that projects radially inwardly and which is provided to bear against the support bars 225, 236 of the tri-wafers. These support bars 225, 236 are held in contact with the inner shoulder 258 by the cover assembly keys 253 by way of press legs 259 that extend through openings 261 formed in the shroud 252. These press legs 259 are curved so that the keys 253 may be rotated into place. The keys 253 also include retaining clips, or latches 260 that are received in and engage a second set of openings 262 in the shroud 252. In this manner, the support bars 225, 236 are held against the shroud 252 so that the terminal and grounding contact and flex portions and the shroud 252 may move together up/down, right/left and in other directions, and preferably as a single unit.

This flexing movement, as shown in the drawings and particularly FIGS. 11-12 and 14-15 thereof, is effected by fixing the shroud 252 and the terminal mating portions at the support bars 225 together as a unit. The shroud 252 is not attached to the connector block 201 and is free to move, but the engagement of the support bars 225 with the shroud 252 defines a floating point for the terminals, while the connector housings 210, 220, particularly along the front faces 218 thereof, defines a fixed point. Although the shroud 252 is fixed to the terminals at the support bars 225, the support bars 225 are able to move relative to the front face 218 of the connector block 201. In this manner, and as shown diagrammatically in FIG. 12, the flexing sections of the terminals emulate a four-point mechanical linkage with the four points shown as B1, B2, B3 and B4. This arrangement permits desired movement of the contact portions (and the shroud) as a group, while keeping the contact portions 214, 230 in their mating orientations, which is preferably parallel to each other.

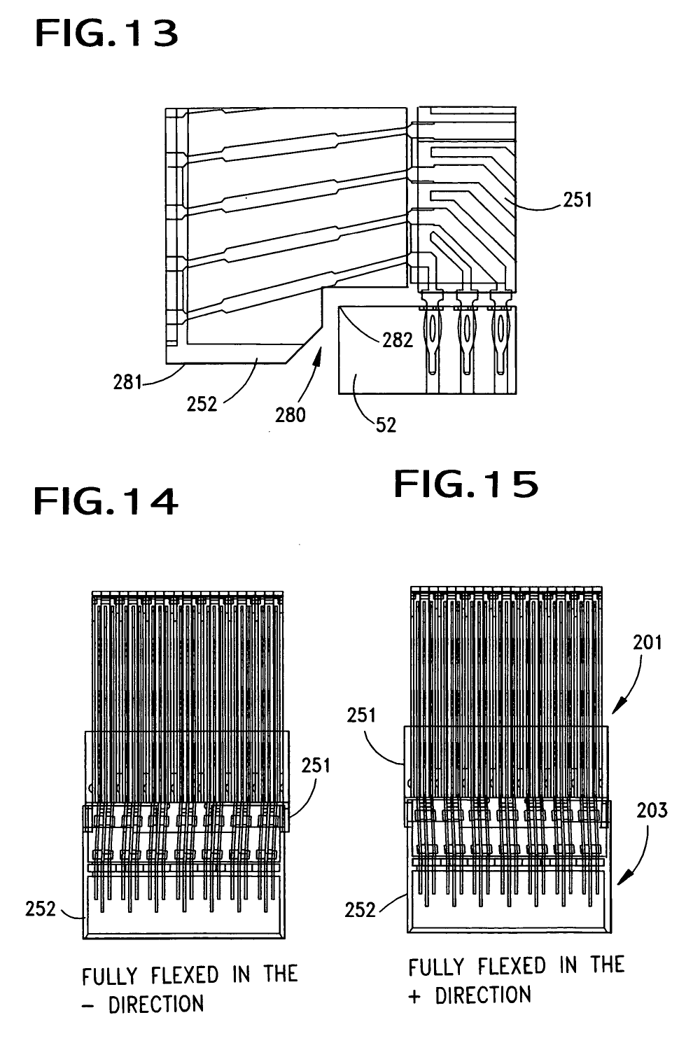

FIGS. 11 and 12 illustrate the flexure of the contact portions of the receptacle in the up or “+Y” direction (FIG. 11) and the downward or “−Y” direction. FIG. 13 illustrates the clearance that is effected between the shroud 252 and the circuit board 52. FIGS. 14 and 15 show the maximum flexure that occurs in the receptacle connector in the two different “−X” (left) and “X” (right) directions that occur within a horizontal plane.

In order to provide unimpeded movement of the shroud and mating region of the receptacle connector 200 in these directions, there is a clearance “C” provided (FIGS. 1 & 2) between the clamp member 251 and the shroud 252 so that the clamp member 251 does not impede the movement of the shroud and its contacts. As illustrated in FIG. 13, the shroud 252 may also include a notch 280 formed along the lower face 281 of the shroud 252 that serves to provide a space between the shroud and the edge 282 of the circuit board to which the connector is mounted. (FIGS. 6 and 11-13.)

As shown in the drawings, such as in FIG. 2, the receptacle connector 200 includes an angled surface 290 that preferably extends around the inner perimeter of the face 291 of the shroud 252. This angled surface 290 acts as a lead-in surface and serves to assist in directing the front face 292 of the opposing plug connector (FIG. 4) by way of a complementary angled surface 293 into the interior opening of the shroud 252

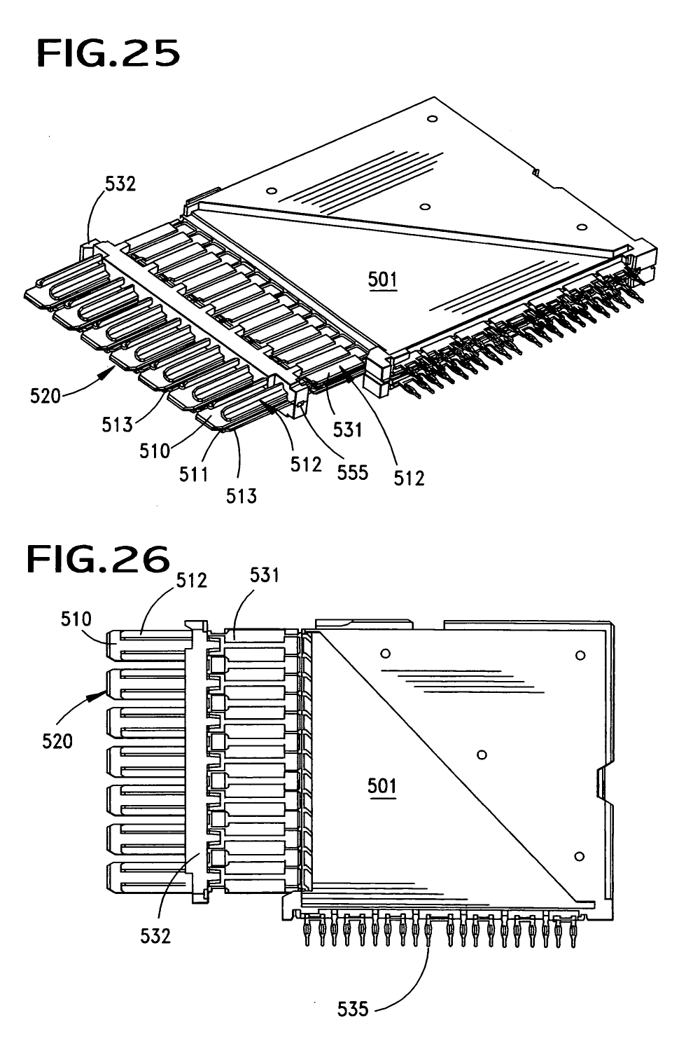

As shown best in FIGS. 7 and 8, the support bars 225 are vertical members that extend vertically across, or transverse to the direction in which the signal and ground terminal contact portions of each terminal assembly extend so that they will be vertical in a connector using vertical arrays of terminals and will be horizontal in connectors using horizontal arrays of terminals. As such, they maintain the terminal contact portions of each terminal array in a predetermined contact spacing. The support bars are best applied to the terminals in this embodiment by insert molding, overmolding or any suitable assembly process such as press-fit, adhesives, etc. The support bars then abut each other, as shown in FIG. 8 when the terminal assemblies are assembled together. The abutting edges of these support bars may have means for engaging each other in the form of slots 555 (FIG. 25), adhesive or the like.

It should be also noted that the flexing connector may include a dielectric comb or spacer 275 that separates the signal terminal set flexing portions from the grounding terminal set flexing portions within each terminal assembly. Two such spacers 275 are preferably used in each terminal assembly and are shown interposed between the signal terminal wafers 210 and the ground member wafer 220. As shown, the spacer 275 is elongated and generally rectangular, with an angled edge 276 located at its bottom so that, as shown, the spacer 275 extends fully (crosswise) between the top and bottom terminals of the signal and the ground terminal array. The spacer is attached to one of the terminal arrays, preferably the signal terminal array, along the interior face thereof so it extends between the flexing portions of the signal and ground member terminal arrays. The attachment is accomplished by way of an interference fit in the embodiment shown in FIGS. 7 & 8, and the spacer element 275 includes an attachment lug 277 defined in the body of the spacer by way of a U-shaped slot 278. The attachment lug 277 preferably includes an enlarged free end 279 that fits into one of the spaces between a pair of terminal flexing portions in the signal terminal array.

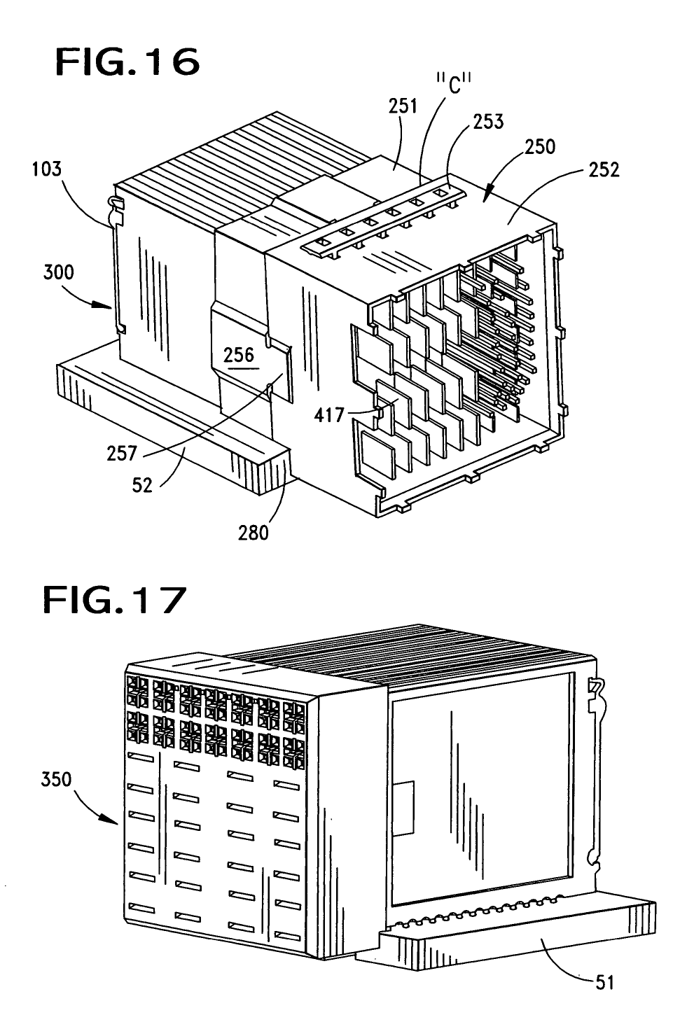

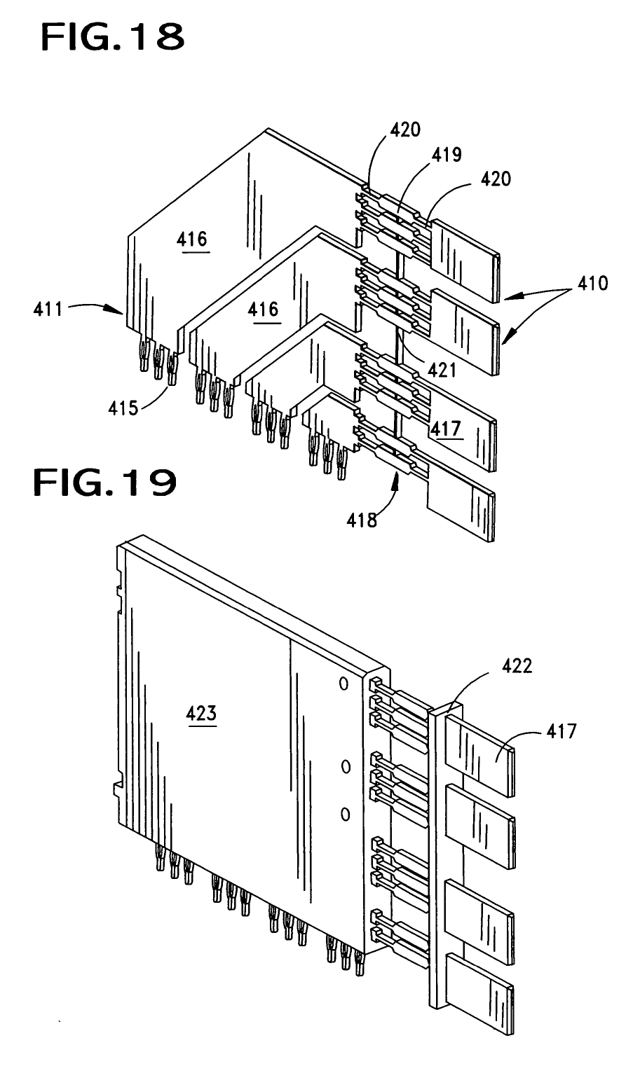

FIGS. 16 and 17 illustrate alternate embodiments of the invention which incorporate power terminals into the connectors. A receptacle connector 300 is shown in FIG. 16 and it can be seen to have many of the same structural components as the receptacle connector 200 previously described, such as the retainer 103, cover assembly 250, including a shroud 252, clamp member 251 and retaining keys 253. It also includes a plurality of connector wafers that are assembled together as tri-wafers in groups of three, and importantly, it includes a plurality of power terminals 410 (FIG. 18) that are formed as part of an overall power terminal set 411 that are supported by an insulative housing 423. (FIG. 19.).

Each of the power terminals 410 includes a mounting portion 415, a body portion 416, a contact portion 417 and a flexing portion 418 disposed intermediate the terminal body and contact portions 416, 417. The flexing portions 418 include the aforementioned center body 419 which is flanked by two, thin flex arms 420. The power terminal flex portions 419 are interconnected together by a vertical lead 421 during manufacture, and that is stamped and formed with the terminals as illustrated in FIG. 18, but then removed from the terminal lead frame punching. A support bar 422 may be molded to the power terminals as illustrated in FIG. 19 and a wafer body 423 may be molded onto all or part of the power terminal set 411. These power terminal wafers may be positioned near sets of signal and ground terminal wafers, or as illustrated in FIG. 16, along one side of the receptacle connector. The support bars 422 in this embodiment are used to fix the power terminal contact portions 417 to a movable shroud as described above.

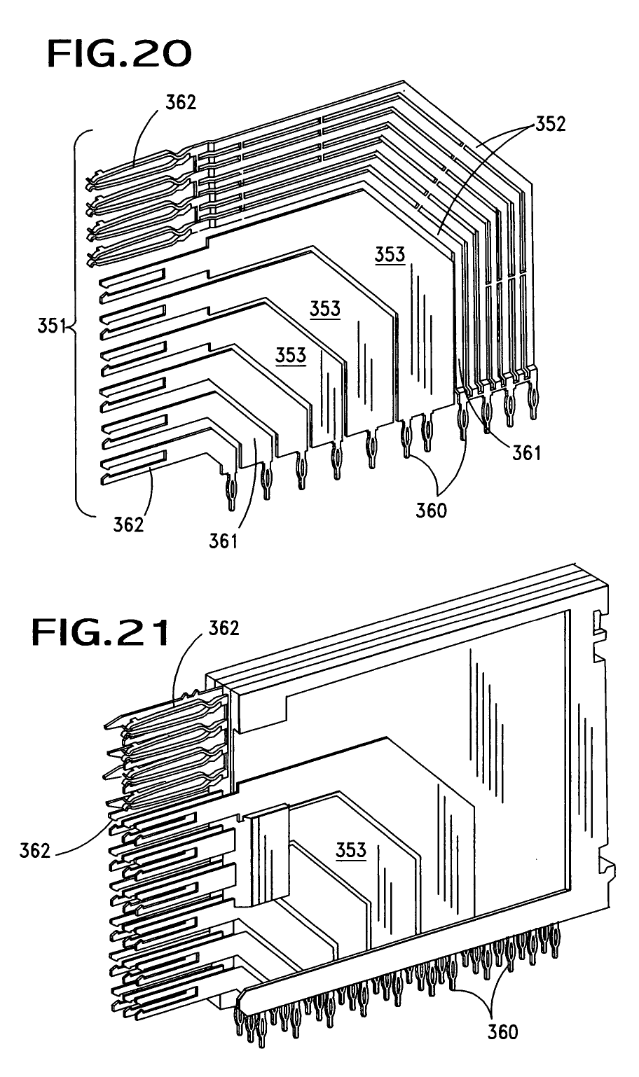

FIGS. 20 and 21 illustrate terminal sets that are used with the plug connector 350 of FIG. 17 which mate with the receptacle connector 300 of FIG. 16. The terminal sets 351 include signal terminals 352 that extend alongside a set of power terminals 353. All of these terminals have mounting portions 360, body portions 361 and contact portions 362 and all of them preferably have slotted contact portions that will receive within their respective slots, either the power, ground or signal contacts of the receptacle connector 300. These terminal sets have a dielectric body molded to them and are sandwiched around a grounding terminal set as in the plug connector of FIG. 4. One set of the signal terminals is shown in FIG. 20, while FIG. 21 illustrates a plug connector terminal assembly with a set of ground terminals flanked by two signal terminal sets, each supported by an insulative housing.

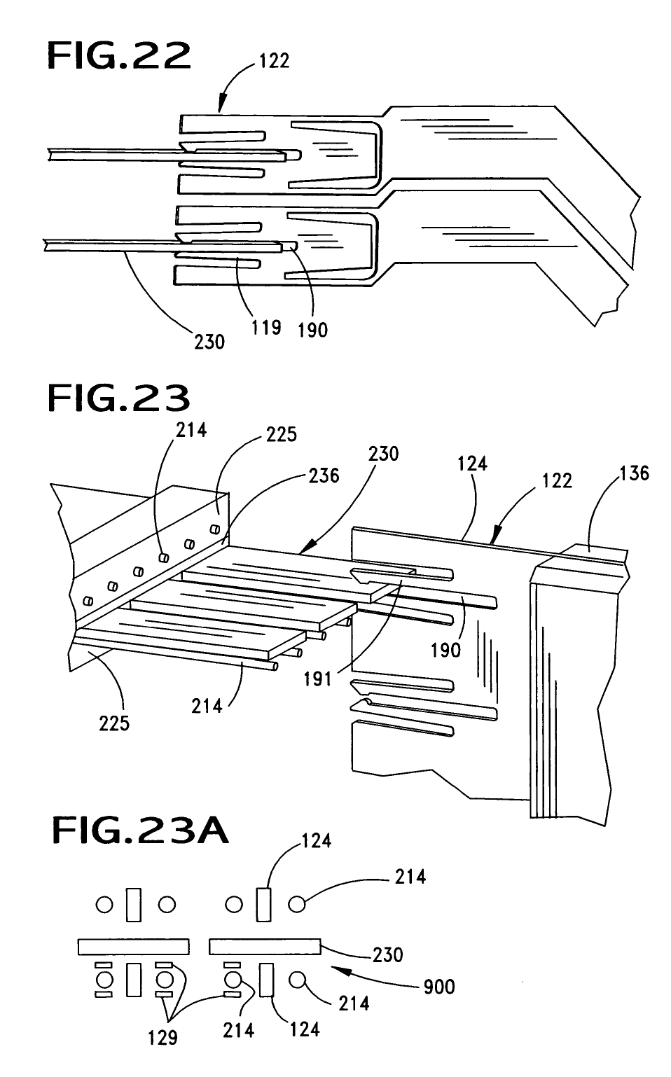

FIGS. 22 and 23 illustrate two different plug grounding shield engagement end embodiments that show how the grounding shields of the plug and receptacle connectors of the present invention mate together. It can be seen that this engagement is a sliding engagement wherein the grounding contacts of the receptacle connector fit through openings 110 in the plug connector cover 108 and are gripped by a pair of contact arms 191 that are stamped into the contact portions thereof. In FIG. 22, the ground blades 230 of the receptacle connector terminals extend in a perpendicular fashion into the slots 190 formed between the two contact arms 191 of the plug connector ground terminal assembly. FIG. 23A illustrates in detail the “microcross” aspect of the connectors of the invention.

In FIG. 23, a receptacle connector terminal assembly is shown oriented horizontally, rather than vertically as shown in previous figures, and the plug connector terminal assembly 136 is shown oriented vertically, and the free ends of the terminal contact portions 214 have been removed for clarity. The ground member contact blades 230 are received within slots 190 located between pairs of contact arms 191. In this manner, the grounds of both connectors intersect each other in a crosswise manner and extend vertically between arrays of signal terminals and further extend horizontally between rows of terminals. This is illustrated schematically in FIG. 23A, where a cross-like pattern of grounds 900 is created in the mating area. In this mating area, the signal terminals 214 of the receptacle connector mate with their opposing female contacts 129 of the plug connector while the ground contact portions 124, 230 of each connector mate in the manner shown. This arrangement isolates the signal terminals through the intersecting ground plane, while simultaneously providing a continuous ground reference through the mating interface of the two connectors.

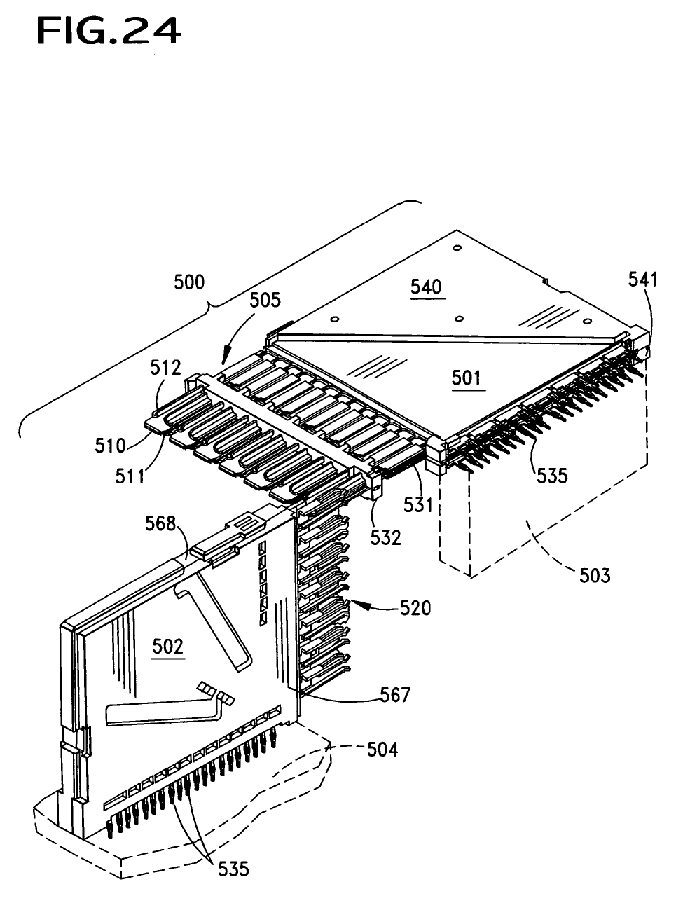

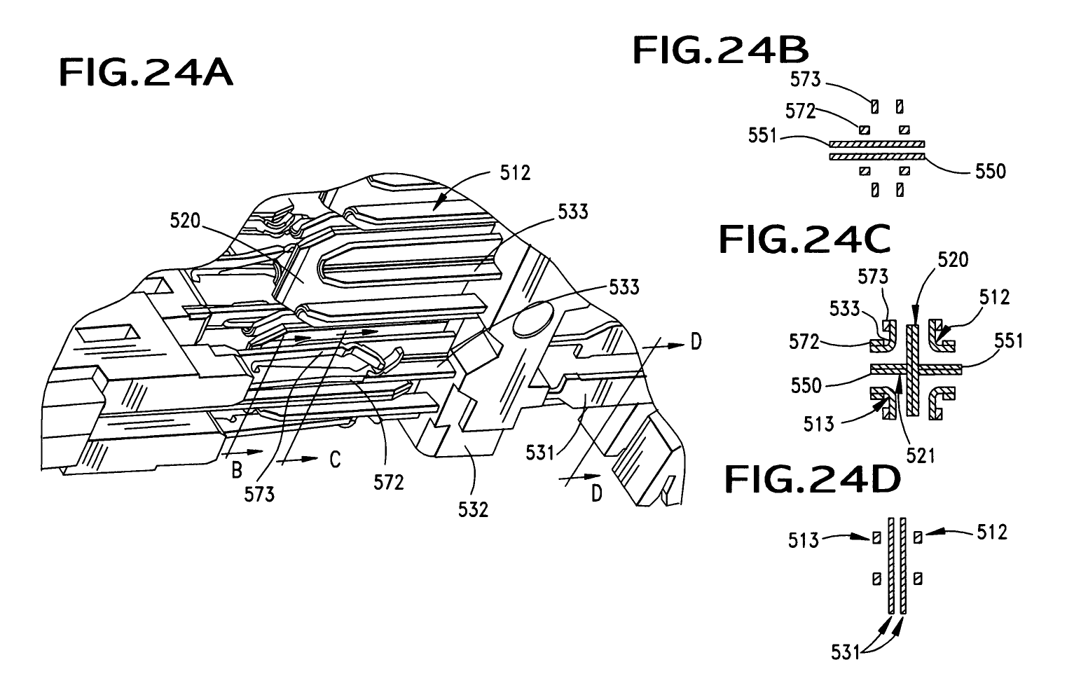

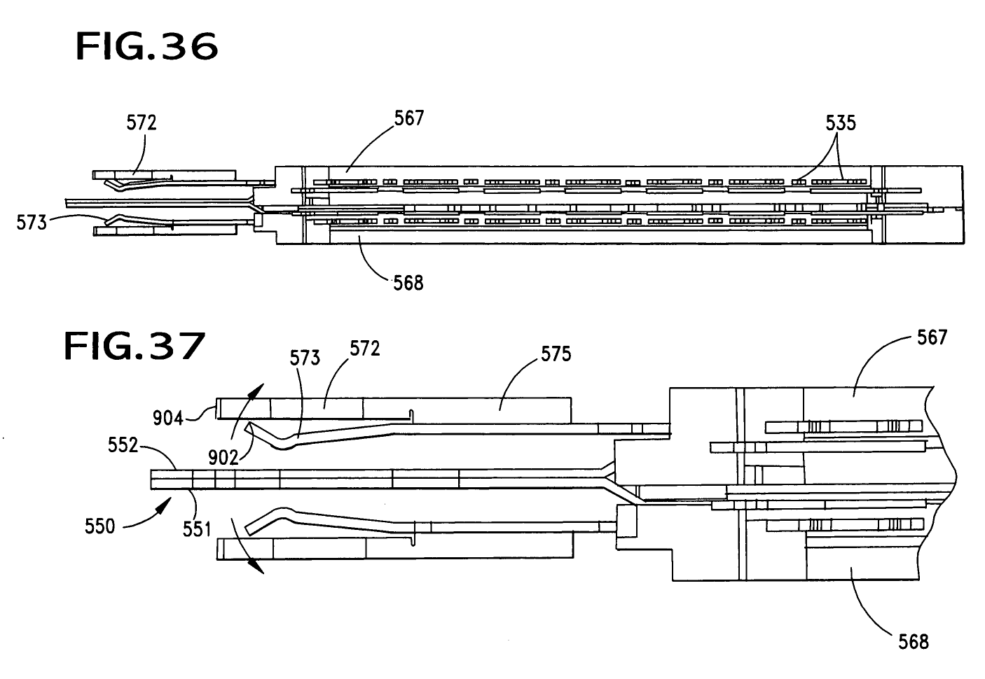

FIGS. 24 through 38 illustrate another embodiment of a connector 500 constructed in accordance with the principles of the present invention. In FIG. 24, only two opposing connector assemblies 501, 502 are shown for clarity. Multiple assemblies 501, 502 are assembled together into a shroud as described above. The assemblies have terminal construction that permits them to be used to connect two circuit boards 503, 504 (shown in phantom) together in an orthogonal manner. The assemblies 501, 502 are constructed in such a manner so that at least one of them, assembly 501, has a terminal structure that can flex in both the X and Y directions, similar to that described above. Similar to the other embodiments described above, the terminals of the assembly 501 have flexural portions 505 interposed between their contact and body/tail portions that permit the contact portions of both the ground and signal terminals to flex for a preselected distance in desired directions. Hence, the assembly 501 may be referred to as the “flexible” assembly, while the terminals of assembly 502 are relatively incapable of the same flexural movement as the terminals of assembly 501, and the assembly 502 may be referred to as a “fixed” connector assembly.

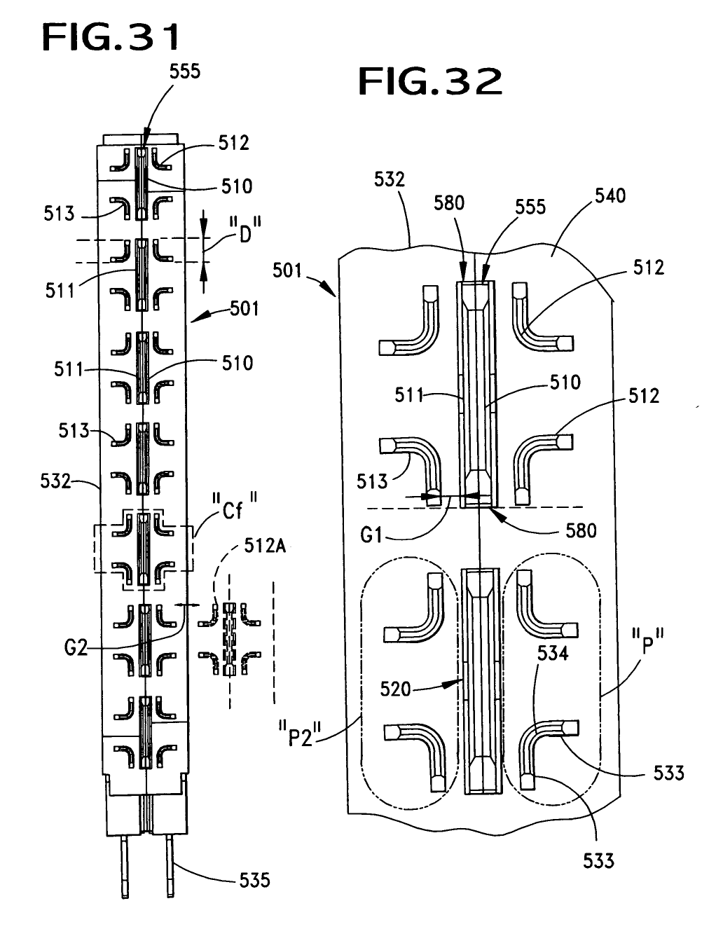

Each of the connector assemblies may be considered as a composite of at least three, and typically four conductive sub-components. For the flexible connector assembly 501, these conductive sub-components may include (as illustrated in FIGS. 28 and 31) a first set or array, of ground terminals 510, a second set or array, of ground terminals 511, a first set, or array, of signal terminals 512 and a second set, or array, of signal terminals 513. As illustrated best in FIGS. 28, 31 and 32, the first and second sets of ground terminals are arranged together in side-by-side fashion, so that they preferably abut each other to form a single, common ground reference 520 of double thickness. (FIGS. 30, 31 & 32.) These two grounds may be considered as cooperatively forming, or defining, a center reference, or line, of the flexible connector assembly. It is also contemplated that a single ground member may be used in this application.

The first and second sets of signal terminals 512, 513 are arranged on opposite sides of the common ground 520. Preferably, it is desired that the first and second sets 512, 513 of the signal terminals are further arranged so that the terminals in the first set 512 are aligned horizontally with corresponding terminals of the second set 513 as shown in FIGS. 31 and 32. It is further desirable to space the signal terminals of both the first and second sets of terminals 512, 513 so that one pair “P” of terminals (FIG. 32) of the first set of terminals 512 is on one side of the common ground 520, and a pair “P2” of terminals of the second set of terminals 513 is on the other side of the common ground 520. In this manner a cruciform arrangement, or pattern, as shown at “CF” is formed (FIG. 31) with the common ground 520 running down the center of the pattern. Additionally, the positioning of the signal terminals 512, 513 is such that their top and bottom edges (along line “D” in FIGS. 31 & 32) are aligned with the vertical ends 580 of the common grounds 520 so that they will maintain their electrical affinity for the ground 520, rather than for each other, which is likely to occur if the tips of the signal terminals 512, 513 extend above the line D. FIG. 31 shows the tips of the signal terminals 512, 513 maintained level with the tips 580 of the grounds 520, while FIG. 32 shows the tips being positioned below the line D.

This cruciform pattern is accomplished by the structure and placement of the signal terminal contact portions 530 that extend forward of the flexural portions 531 of the terminals and the terminal support bar 532, which as described previously, is preferably formed from an insulative material and fits within a shroud or other carrier member. The terminal contact portions 530 of this terminal assembly are formed in a general L-shape with two leg portions 533 joined together at a junction 534 therebetween. As shown in the Figures, the two leg portions 533 of each signal terminal contact portion 512 extend along and away from the common ground 520 (generally parallel and perpendicular thereto). Because the two leg portions 533 are joined together, they will be characterized in this description as “solid” contact portions. The contact portions 530 and the flexural portions 531 are joined to tail portions 535 by terminal body portions supported by the insulative housing 540. The L-shape of the terminals provides strength and redundancy to the signal contact portions.

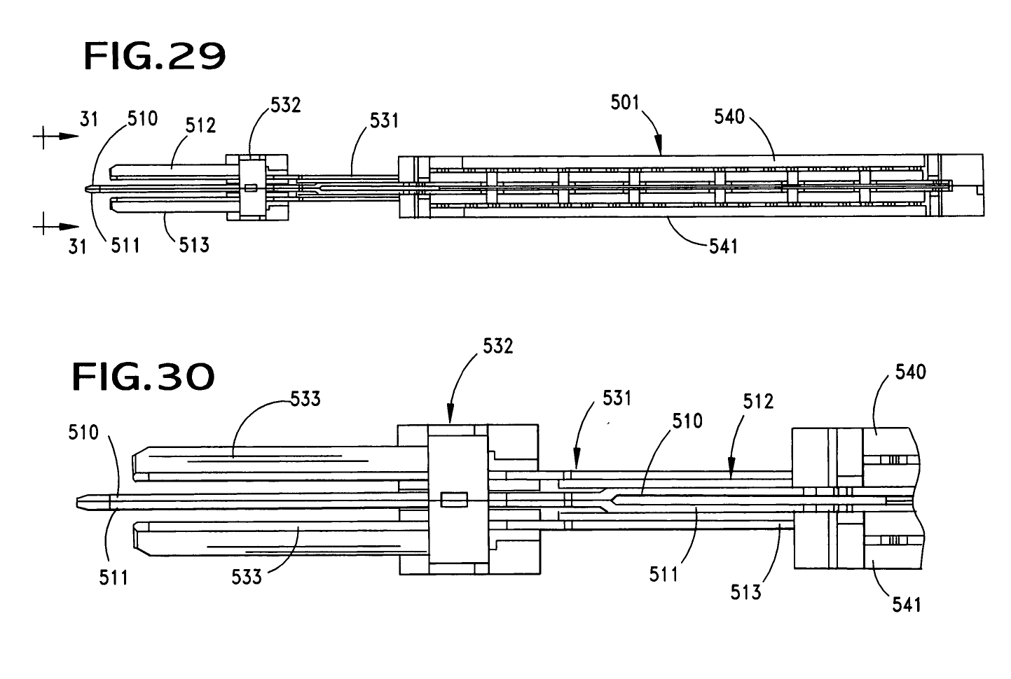

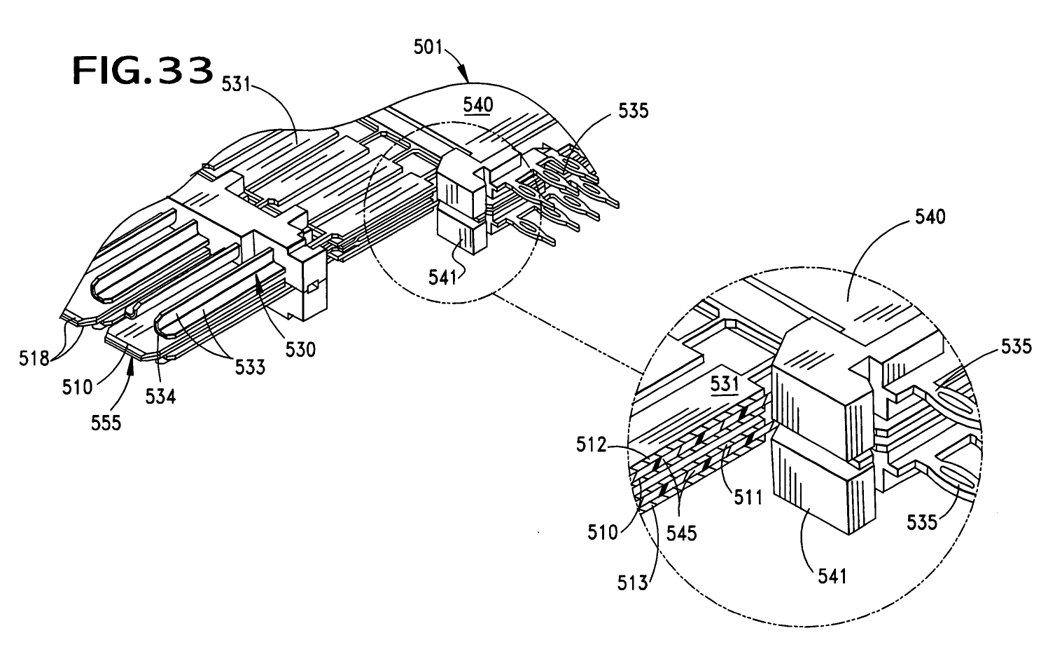

FIG. 33 illustrates, in detail, the sandwiched, or layered, construction of the flexible connector assembly 501. The first and second ground terminal sets 510, 511 have contact portions that preferably take the form of flat contact blades 518 that abut each other to form the common ground 520, but they diverge away from each other in the area of the flexing portions 531 (FIG. 30) located rearwardly of the terminal support bar 532 as shown in FIG. 30. The first and second signal terminal sets 512, 513 are partially housed or enclosed within insulative bodies 540, 541 (FIGS. 29 & 30) that support, and at least partially envelop body portions of the terminals. The tail portions 535 of the terminals project from one side of these insulative bodies 540, 541 while the contact portions project from another, and preferably adjacent side thereof.

In operation, the insulative bodies 540, 541 that house the first and second sets of signal terminals 512, 513 are assembled over and on opposite sides of the first and second ground terminal sets to form the wafer-like fixed connector assembly 501. Additional insulative spacer elements 544, 545 (FIG. 33) which may be either separate elements or formed as parts or extensions of the insulative bodies 540, 541, may be provided between the first and second terminals 512, 513 and the ground terminals 510, 511 in the flexing portion area 531 to prevent unintentional shorting between the signal and ground terminals in this area and, if desired, to provide a dielectric material therebetween. As described with earlier embodiments, this entire terminal assembly may be inserted and removed as a single unit from either the plug or the receptacle connector, thereby eliminating the need for entire disassembly of the connectors for maintenance and/or repair.

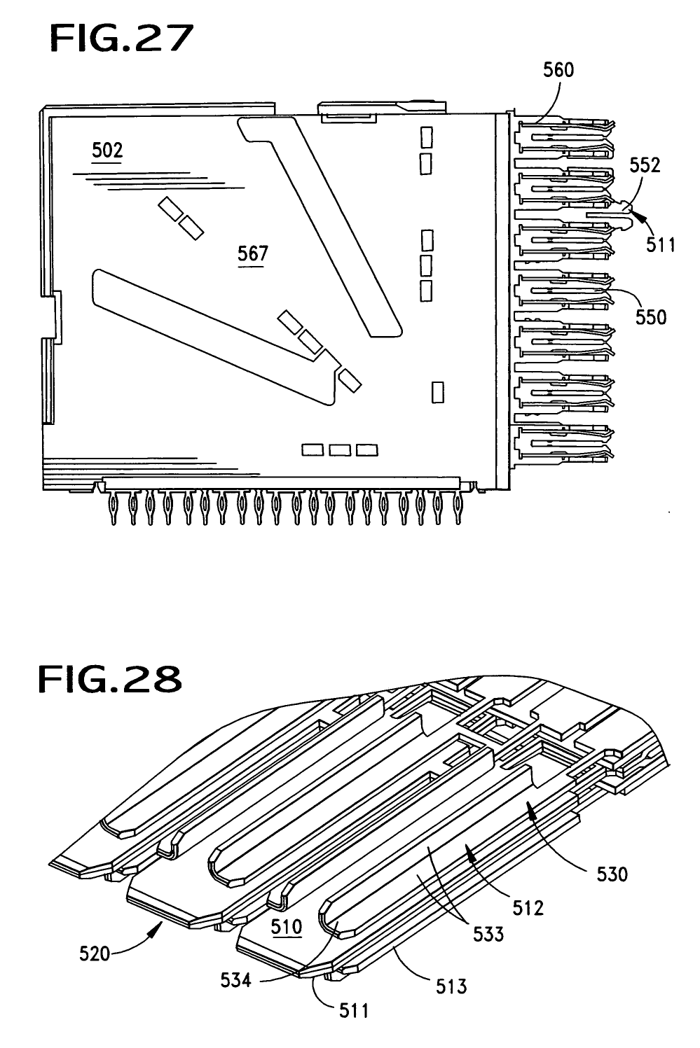

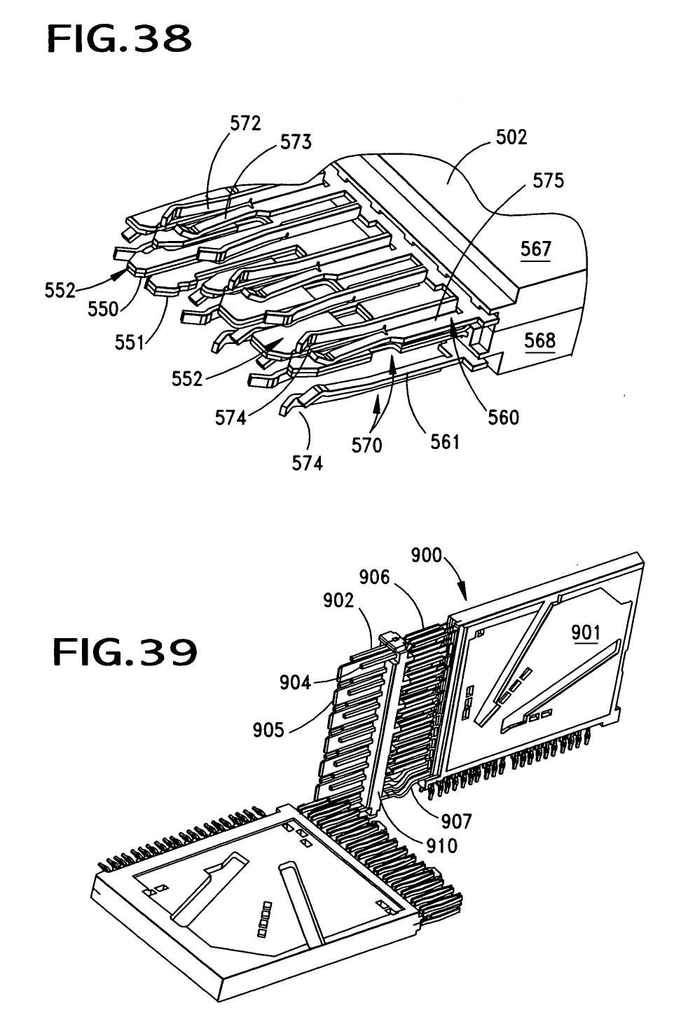

The fixed connector assembly 502 also contains, as shown best in FIGS. 27 and 38, corresponding opposing terminals. These terminals include first and second sets of ground terminals 550, 551, having flat blade contact portions 552. The first and second ground terminals abut each other in the contact portion areas 552. These ground terminals combine to form a center common ground 521 that runs between the first and second signal terminal sets 560, 561, and preferably down the center of the connector assembly 502. Both of the first and second terminal sets 560, 561 are also partially enclosed by insulative bodies 567, 568 that serve to prevent unintentional shorting between the signal terminals and the ground terminals. It will be understood that, if desired, portions of the signal or ground terminals may be bent into contact with opposing ground or signal terminals as described with respect to the other embodiments of the invention.

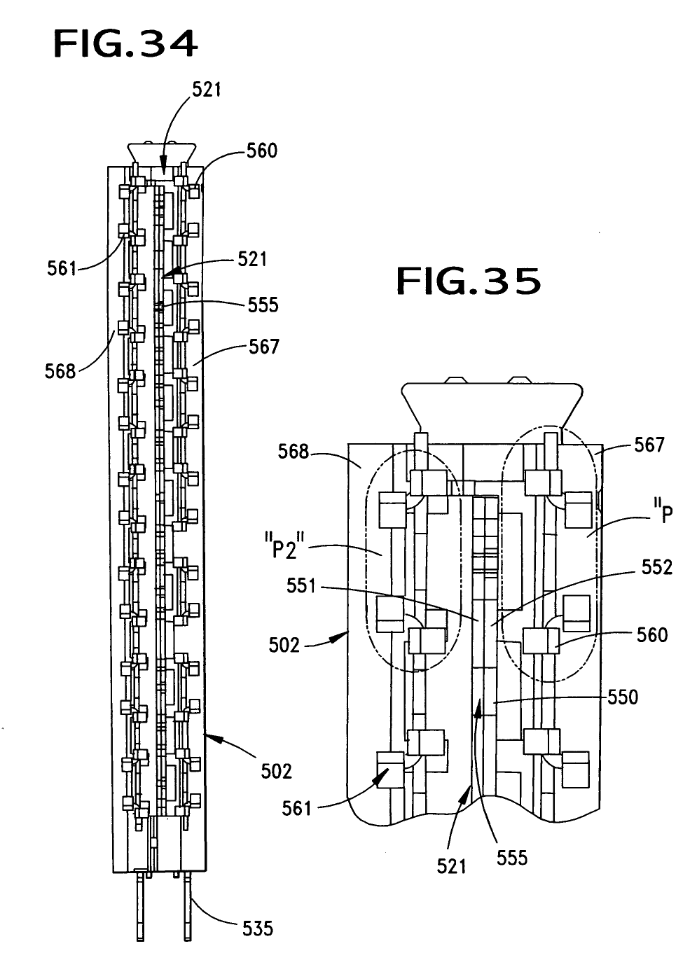

Turning to FIG. 38, it can be seen that the contact portions 570 of the first and second terminals 560, 561 are also generally L-shaped. These contact portions differ from the “solid” contact portions 530 of the flexible connector assembly in that they include bifurcated or dual contact arms, or beams, 572, 573 that are separated by an intervening space 574. These contact arms 572, 573 extend forwardly from a body portion 575, and the contact arms 572, 573 are disposed so that one of them extend along the ground terminal blade portions, while the other of them extends away from the ground terminal blade portions (generally parallel and perpendicular thereto). These contact portions 570 are also arranged in pairs flanking each side of the common ground (FIG. 34) and the contact portions of the first set of signal terminals are preferably aligned with the contact portions of the second set of signal terminals, as represented by P and P2 in FIG. 35. They are also preferably arranged in a cruciform pattern so that they will reliably mate with the L-shaped contact portions of the flexible connector assembly. The dual contact arms are of different lengths, with one contact arm being longer then the other so that during mating, the shorter contact arm may easily deflect within the extent of the other contact arm.

This is illustrated best in FIGS. 37 and 38, where it can be seen that the horizontally extending contact arm portions 572 (when the terminal assembly is held upright) have a contract length that is larger than the vertically extending contact arms 573. In this regard, the free ends 902 of the one contact arms 573 are free to deflect along the paths of the arrows in FIG. 37 and move within the extent, or “cup” of the other contact arm, and not interfere with the free ends 903 of the other contact arms 572. This difference in length also affects the extent to which each contact arm deflects and reduces the peak insertion force of the connector. This reduction is obtained by one-half of the paired contact arms (the longer ones of each pair) making contact with their opposing solid contacts 530 of the receptacle connector and subsequently the shorter contact arms contacting the opposing solid contacts 530.

FIG. 24A is an enlarged detail view illustrating the mating engagement of the two L-shaped contact terminal assemblies. As shown therein, the horizontal contact arm portions 572 will be the first of the two contact arm portions 572, 573 to make sliding engagement with surfaces 533 of the solid L-shaped contact beams 512. The initial peak insertion force includes only the force required to mate the longer contact arms 572 with the solid contact beams 512, instead of mating both contact arms 572, 573 at once.

This embodiment also involves the use of a “microcross” arrangement as shown in the sectional views of FIGS. 24B-24D. FIG. 24B is a sectional view taken of the four sets of terminals of the fixed terminal assembly taken along lines B-B thereof. In this section the contact arms 572, 573 are arranged as shown in an L-type orientation and spaced apart from the double ground 521. In the mating region, as shown by FIG. 24C, taken along lines C-C of FIG. 24A, the two common grounds 520, 521 of the fixed and flexing terminal assemblies intersect to form a cross, with the signal terminals of the two connector assemblies arranged as shown. In FIG. 24D, taken along lines D-D of FIG. 24A, the flexing portions are arranged in equal spacings and alignment on opposite sides of the common ground 521 of the fixed terminal assembly. In this manner, the signal terminals are maintained at a desired spacing from the ground to encourage coupling between the signal terminals and the ground.

The use of double grounds as shown is beneficial because in the body portion of the connector assemblies, the grounds are spaced apart from each other so that each such ground terminal will provide a reference for the signal terminal(s) closest to it, and will provide electrical isolation between the signal terminal(s) next to it and from that away from it, i.e., in FIG. 30, the ground terminal(s) 510 in the body portion area provides a ground reference to signal terminal(s) 512, and isolation from signal terminal(s) 513. As shown in FIGS. 31-32, the signal terminals 512, 513 may be spaced a distance “G1” from the reference grounds 520 (FIG. 32) that is less than the distance “G2” between it and a corresponding signal terminal 512A of an adjacent terminal assembly as shown in phantom in FIG. 31.

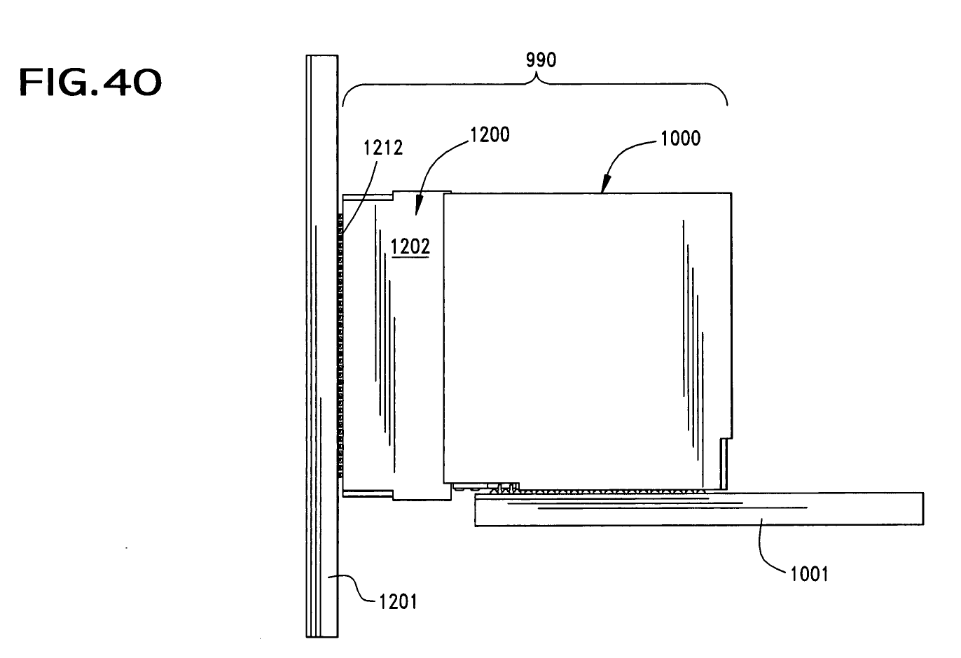

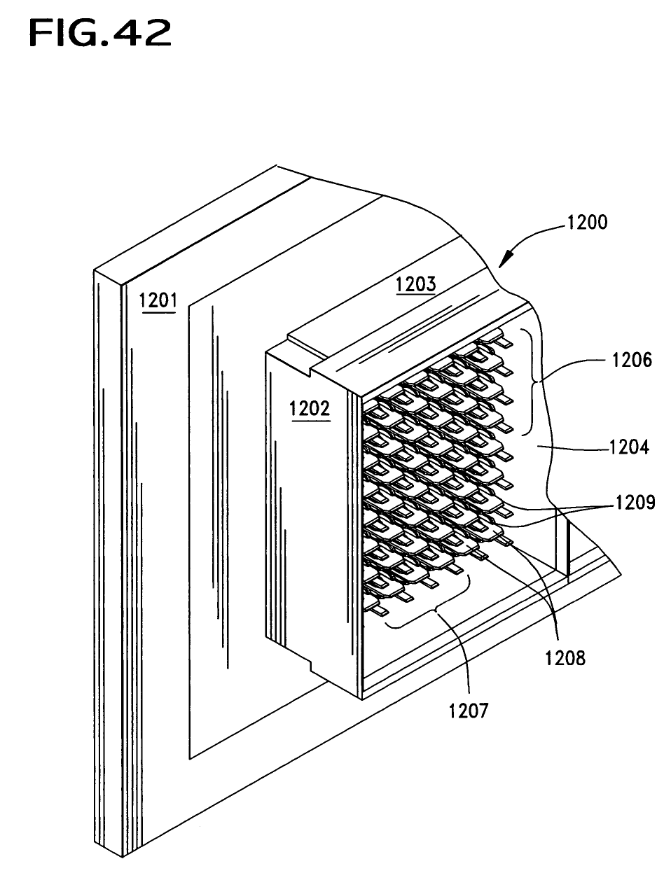

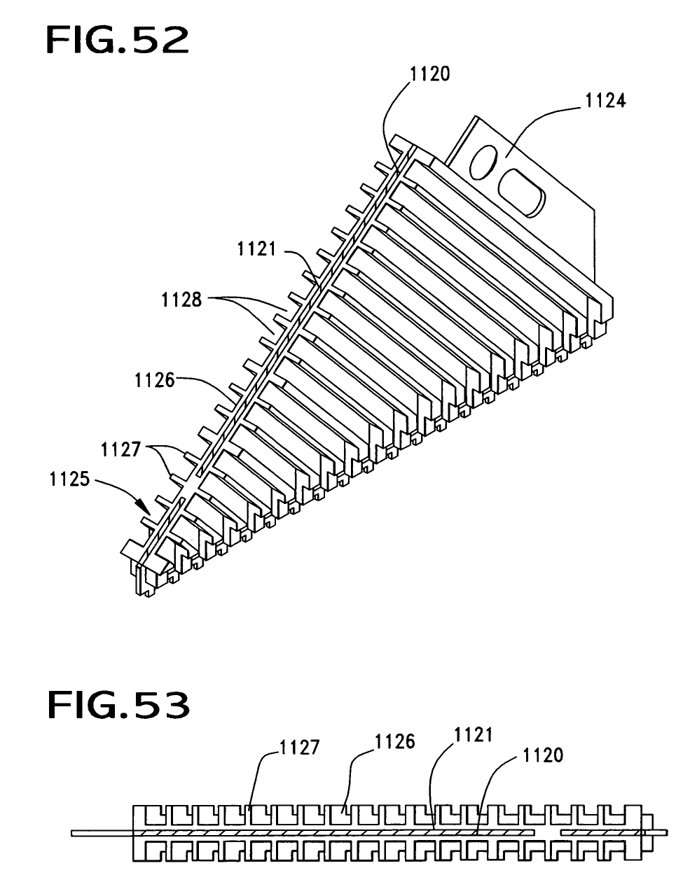

Another embodiment of a connector assembly constructed in accordance with the principles of the present invention is illustrated in FIGS. 40-55. In the embodiments described hereinafter, a ground structure is provided for each terminal assembly that follows, or “tracks” each of the signal terminals for their entire length through the terminal assemblies from the point where the terminals enter their supporting body to the point where they exit the supporting body. In this manner, the ground structure partially encompasses each of the signal terminals.

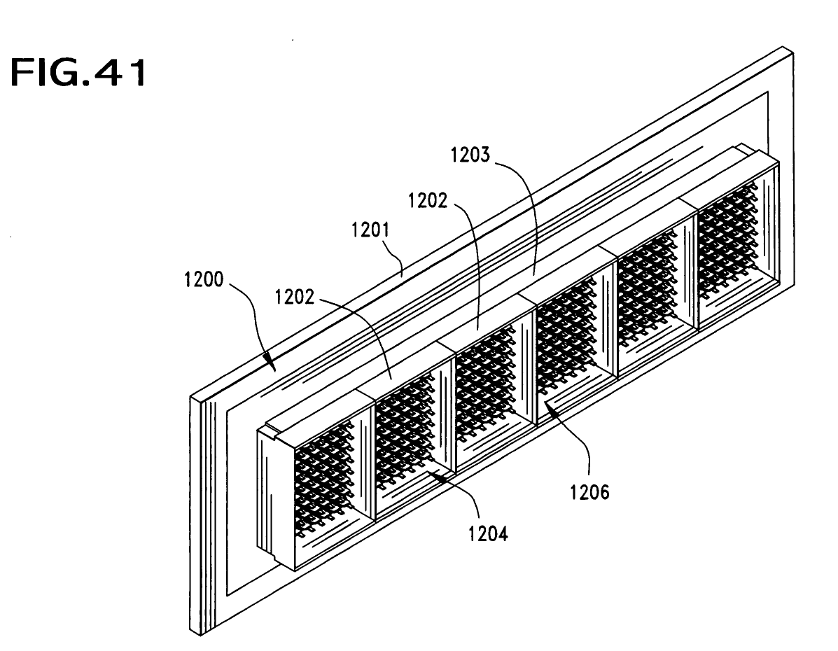

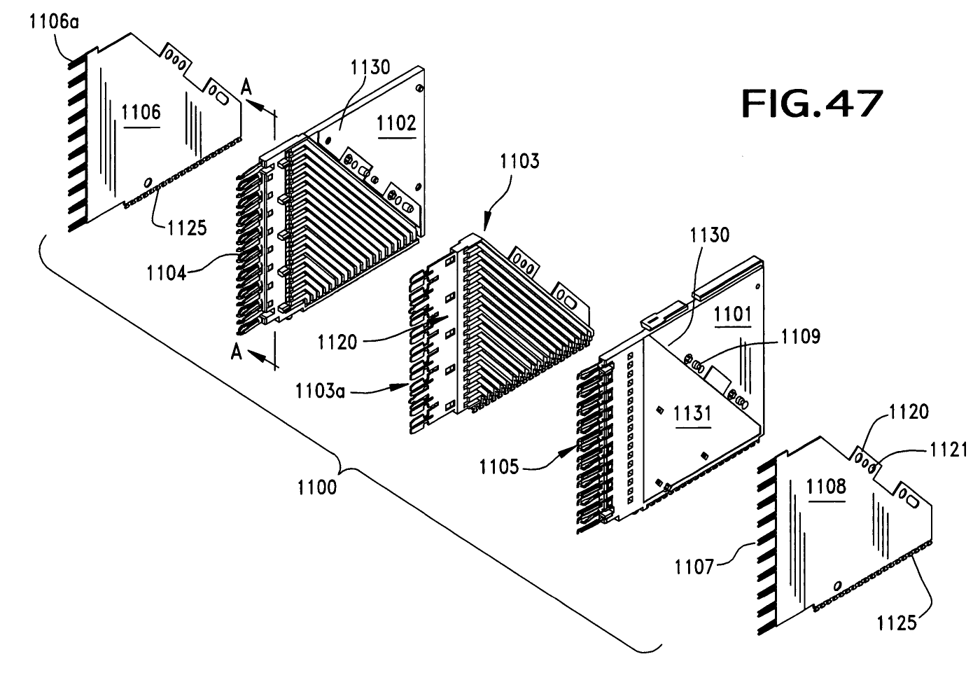

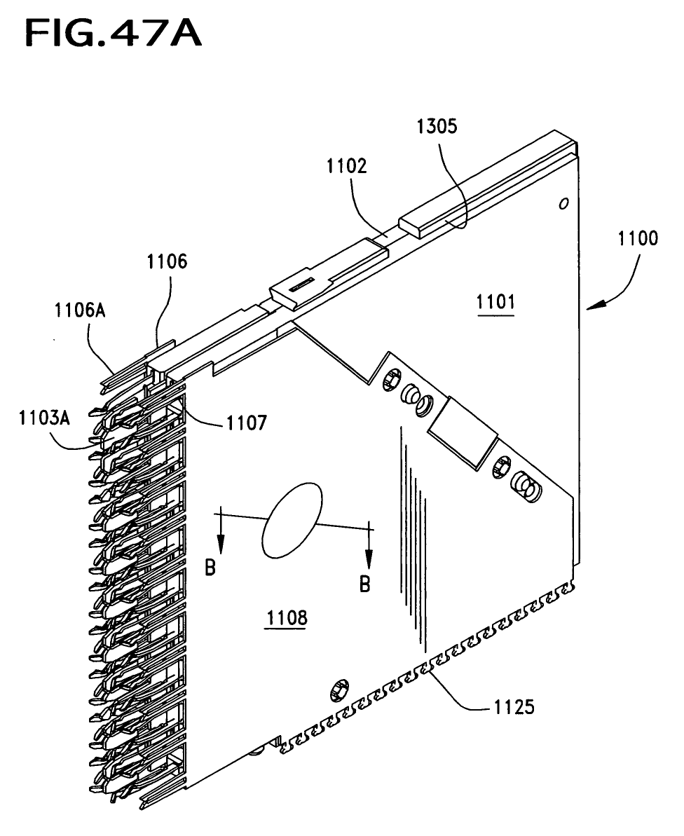

As illustrated in FIG. 40, the connector assembly 990 is used to connect together two circuit boards 1001, 1201. The connection illustrated is shown as an orthogonal connection, but it will be understood that other connector orientations may also be utilized such as parallel orientations and the like. The connector assembly 990 utilizes two mating connector components, with one shown as a hollow receptacle, or header connector 1200 (FIGS. 41-46) and the other shown as a projecting male, or plug connector 1000 (FIGS. 47-55).

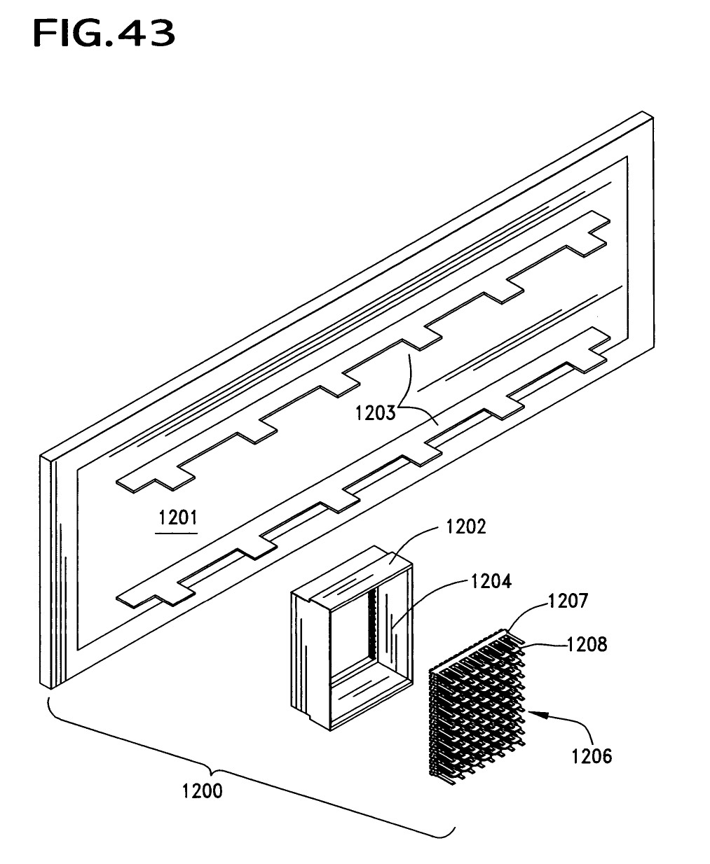

As shown in FIGS. 41 and 43, the header connector 1200 may include a hollow header frame 1202 that has a plurality of intersecting walls that are spaced apart from each other in order to define a plurality of hollow receptacles 1204. Each receptacles houses a conductive terminal arrangement 1206 that includes both signal and ground terminals. Two support bars 1203 may be utilized to hold the header components together as a single unit. In this regard, the header frame 1202 may be formed from a plurality of individual receptacle frames, or modules 1202, as shown in FIG. 43 or it may includes a receptacle frame formed as a single piece with multiple receptacle openings.

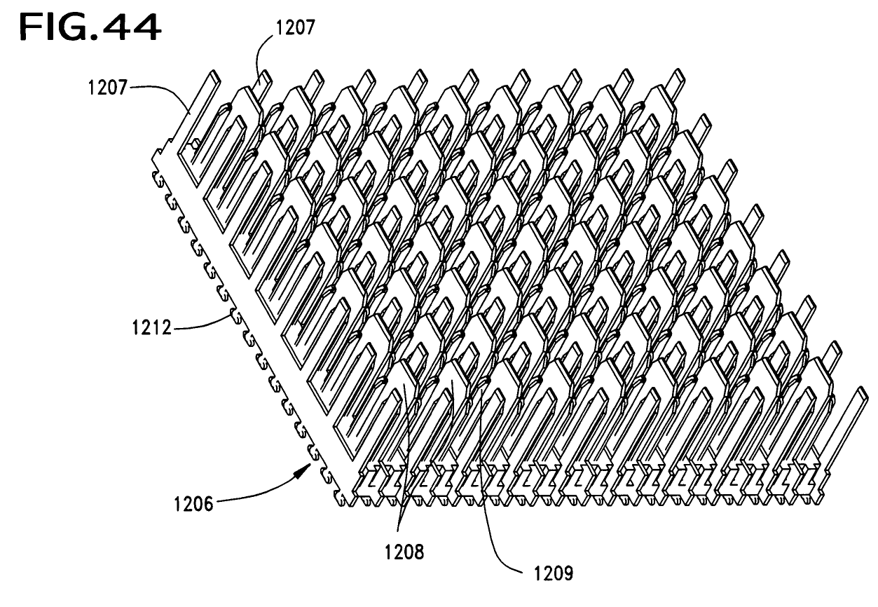

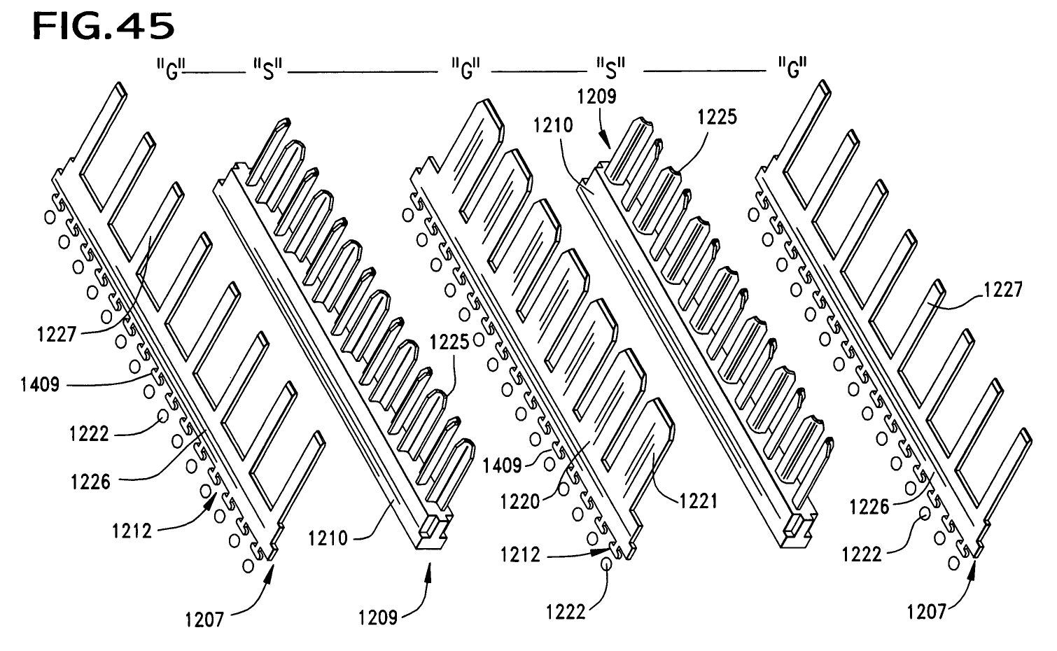

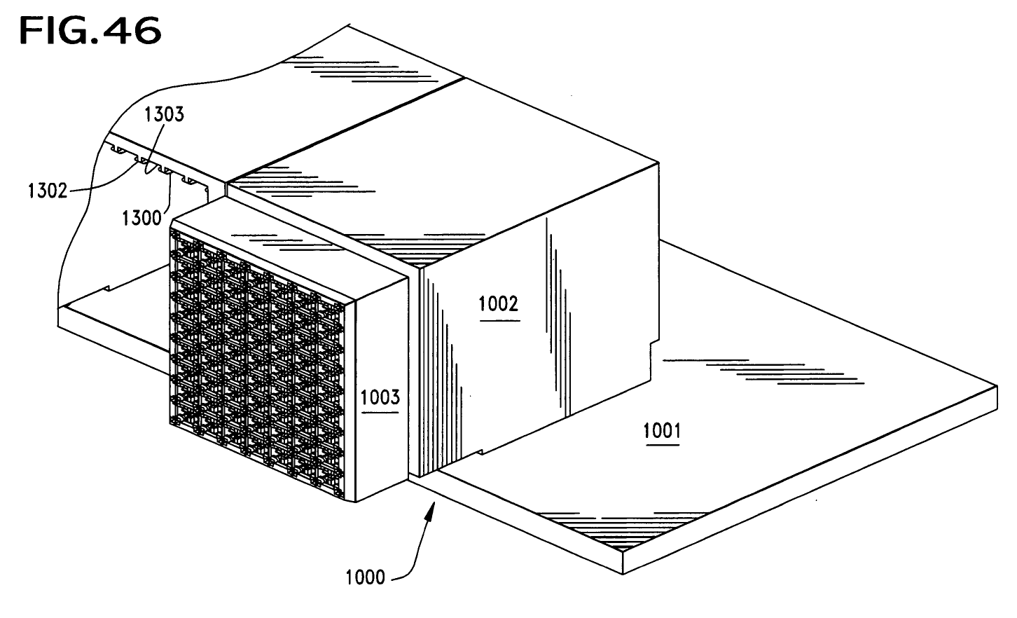

One such terminal arrangement 1206 is illustrated in detail in FIG. 44 and it includes an arrangement of distinct sets or arrays of conductive terminals 1207-1209. The terminals are arranged in a manner such that one set, or a center linear array, of ground terminals 1208 is preferably formed from a single piece of conductive material, typically sheet metal with a base portion 1220 and a plurality of contact portions 1221 shown in the form of flat contact blades that project from the base portion 1220. Tail portions 1212 are also formed as part of the terminal set 1208, and are illustrated in FIG. 45 as either surface mount tail portions 1409 or a plurality of solder balls 1222 which arranged as part of a ball grid array. Other tail portions, such as compression contacts, compliant pins or the like may also be used.

The center array of ground terminals 1208 is flanked on both sides by linear arrays of signal terminals 1209, and these terminal arrays 1209 also include base portions 1210, although they are formed from an insulative material, rather than the conductive base portions of the ground terminal arrays. The contact portions 1225 of the signal terminals 1209 are formed as L-shaped solid contact blades in the fashion described above and shown in FIGS. 31 and 32, but without any flexing portions being formed with the terminals. The contact portions 1225 project above and away from the signal terminal array base portion 1210 the signal terminals 1209 also have tail portions which are not shown in FIG. 45, but which protrude through or from the insulative base portions 1210 thereof.

Lastly, each terminal assembly of the receptacle connector preferably includes a pair of end ground terminal member, or terminal arrays 1207, each of which has a linear conductive base portion 1226, tail portions 1212 and contact portions 1227 extending therefrom. In this manner, the signal terminals of each receptacle terminal assembly are surrounded in a linear fashion by ground terminals to define an arrangement of ground-signal-ground-signal-ground terminals (or G-S-G-S-G as illustrated in FIG. 45). This terminal assembly 1206 will mate with an opposing terminal assembly 1100 of a mating plug connector 1000. In this manner, the signal terminal sets 1209 are flanked on both sides by ground terminal sets 1207 or 1208, widthwise through the receptacle connector 1200 as shown. The ground terminals of the arrays 1207, 1208 are different. As illustrated in FIG. 45, the central ground terminal array 1208 has wide contact portions 1221 and the two flanking ground terminal arrays 1207, 1208 have thin contact portions 1227. Preferably, these ground terminal array contact portions 1221, 1227 are aligned with each other widthwise, or transversely across the linear arrays of the terminals of the receptacle connector assembly 1206.

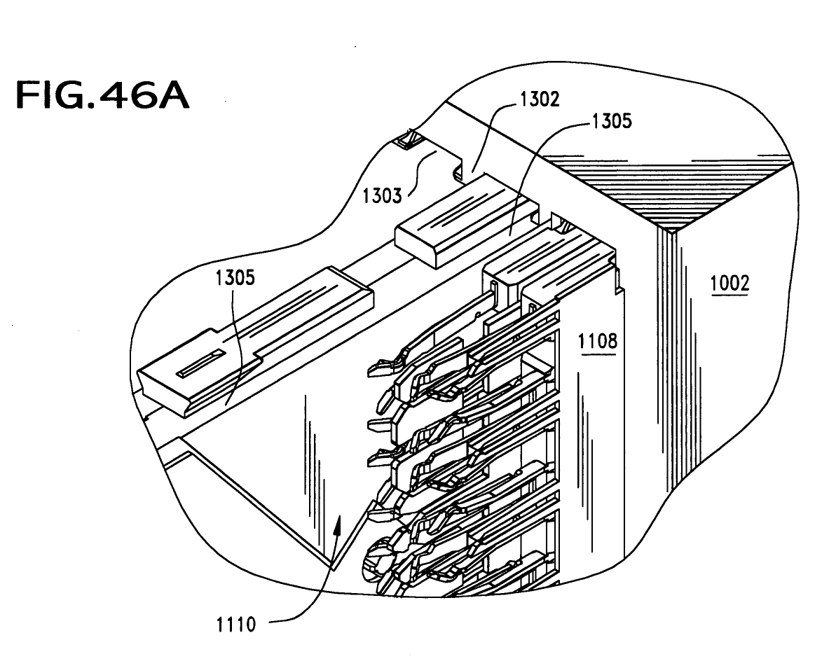

FIG. 46 illustrates a plug connector 1000 of the connector assembly of the invention that is used to mate with the header connector 1200. As shown, the plug connector 1000 includes a housing 1002 that encloses a plurality of terminal assemblies (not shown) that are mounted to the circuit board 1001. A cover member 1003 is made part of the connector 1001 and serves to cover the projecting mating ends of the contact portions of the terminal assemblies thereof. The housing 1002 defines a hollow shell, typically with open front and rear sides, that receives each one of the terminal assemblies therein and holds them in a preselected orientation in which each terminal assembly is held within an individual channel 1300 that is defined within the shell by a series of rails 1302 that are formed on the inner surface 1303 of the housing. These rails, as best shown in FIGS. 46 and 46A, have an inverted “T”-shape and they engage the terminal assemblies along slots 1305 formed therein.

One of the multiple terminal assemblies 1100 of the plug connector 1000 is illustrated in an exploded format in FIG. 47. As shown, the plug terminal assembly 1100 includes a central ground terminal support member, 1103 having a plurality of contact portions 1103A shown as dual member, slotted contacts. The central ground terminal support member is flanked by two signal terminal support members 1101, 1102 in the form of shells that each preferably include insulative housings 1130 that may be molded over a set of conductive terminals 1104, 1105. The signal terminal shells 1101, 1102 are likewise flanked by a pair of ground members 1106, 1108 that preferably take the form of flat planar plates which have contact portions 1107, 1106 extending therefrom along one edge thereof as well as tail portions 1125 that extend therefrom along another edge thereof. The two edges of the ground members from which the contact and tail portions project are preferably disposed adjacent each other as illustrated.

FIG. 47A shows all of the components of the terminal assembly assembled together into one assembly. In this assembly, the two signal terminal support members 1101, 1102 are interengaged together with the central ground member 1103, and the two planar ground members 1106, 1108 are applied to the ends of the assembly 1100. The planar body portions of the end ground members 1106, 1108 are preferably received within corresponding recesses 1131 formed in the exterior faces of the signal terminal support members 1101, 1102.

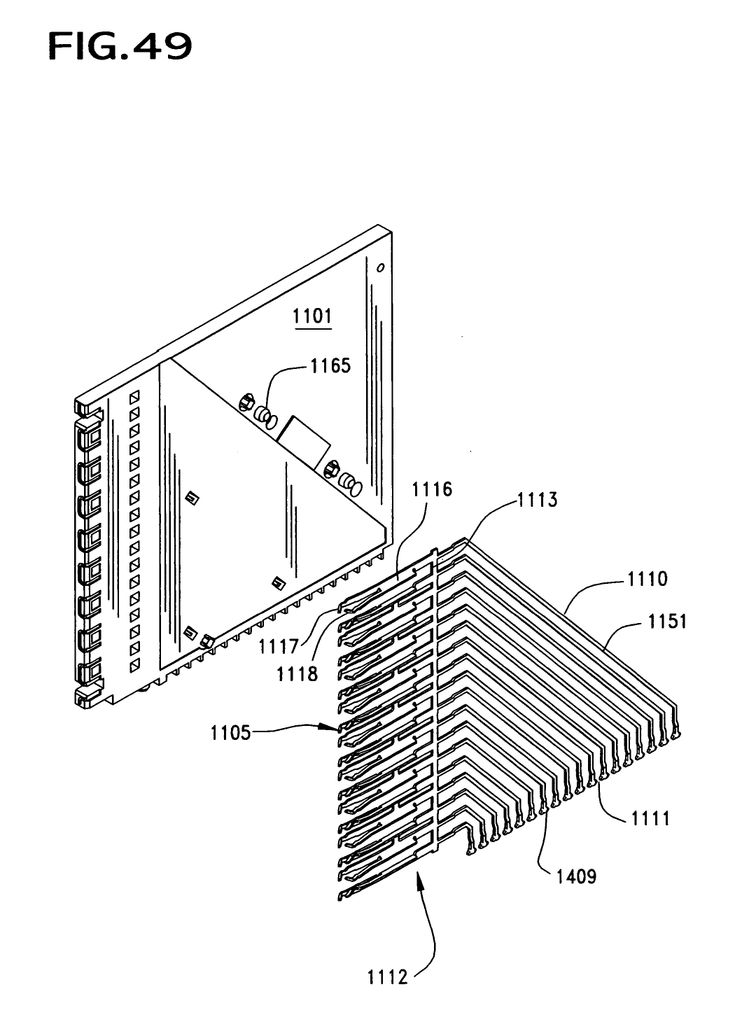

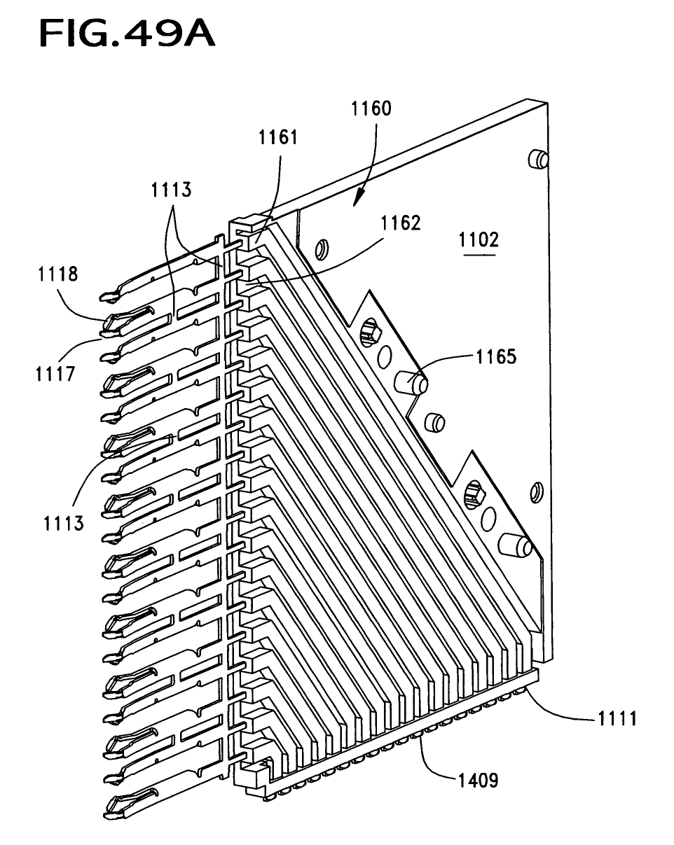

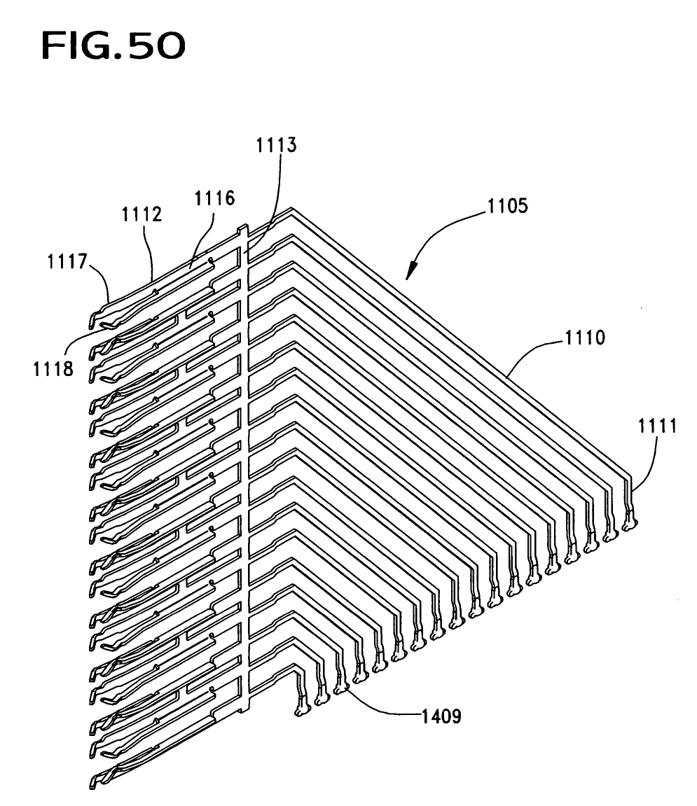

FIG. 49 illustrates the rightmost signal terminal support member 1102 shown as a lead frame 1105 that is separated out from the signal terminal housing, or shell 1131 of this signal terminal support member 1105. The conductive lead frame includes contact portions 1112, tail portions 1111 and body portions 1110 that interconnect the contact and tail portions together. As shown in FIG. 50, the terminals may be connected together by tie 1113 which are removed such as by singulation or cutting, before the terminal set is mounted in its insulative housing 1130. The terminal set is preferably mounted to the housing 1130 by insert or over molding the terminal support member shell over the terminal set 1105. The contact portions 1112 of the signal terminal set 1105 of the plug connector preferably include pairs of contact arms 1117, 1118 that extend in different planes from a body portion 1116. The length of one of the contact arms 1118 is shorter than the other contact arm 1117 so that the two contact arms will not interfere with each other during mating of the terminal set to the signal terminals of the header connector. As stated above, the contact arms 1117, 1118 are arranged in a L-shaped pattern so that both contact arms make contact with two opposing contact arms of the mating receptacle connector.

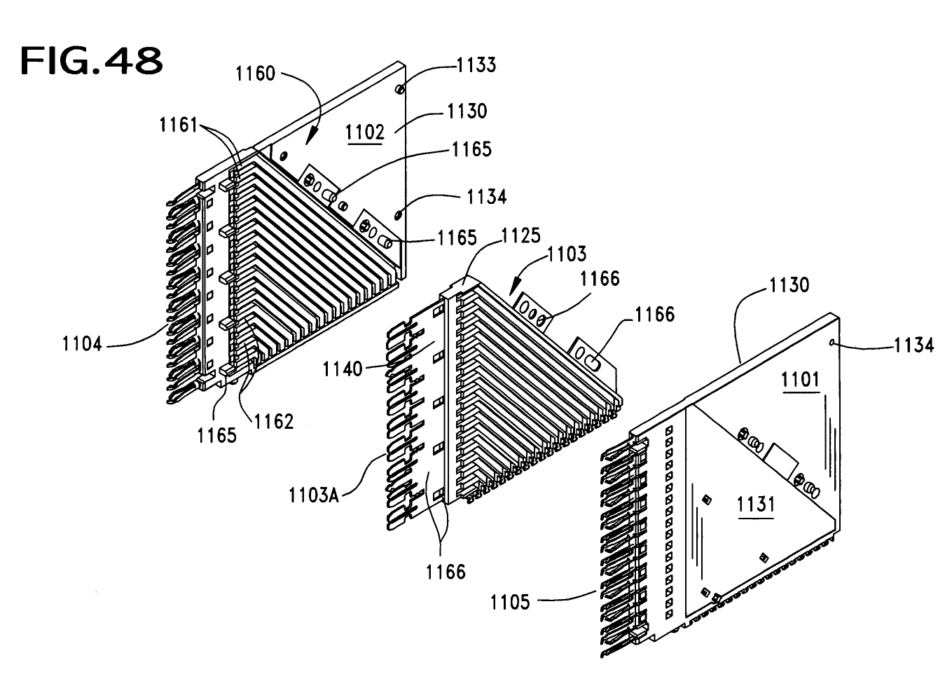

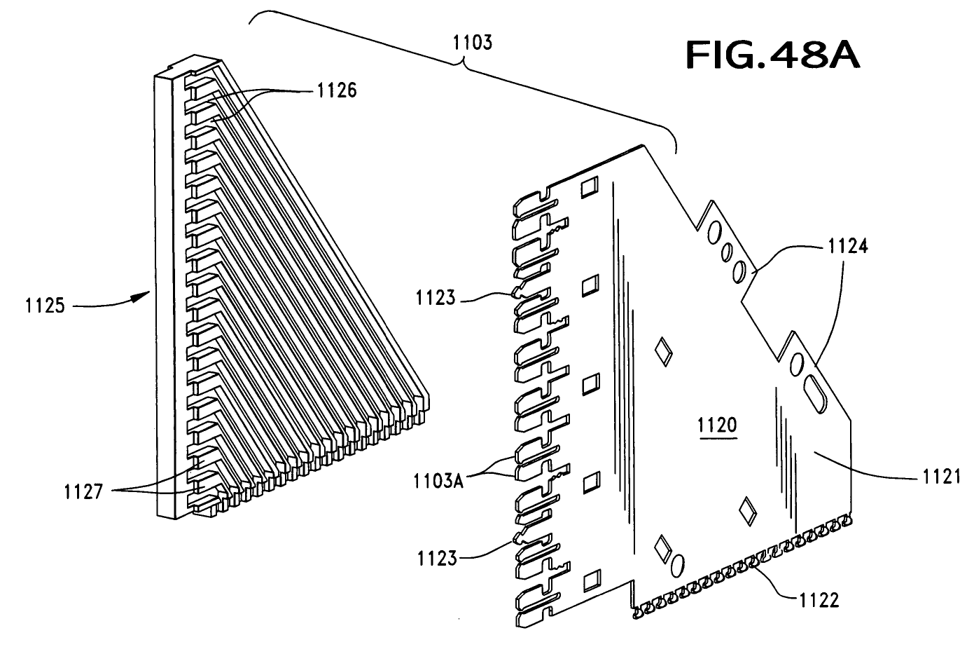

FIG. 48 illustrates the two signal terminal support members 1101, 1102 spaced apart from their associated central ground terminal support member 1103. The signal terminal housings 1130 may be provided with posts 1133 and openings 1134 that mate together with each other for assembly and various attachment techniques may be used to hold them together such as ultrasonic welding, plastic welding, interference fit, adhesives or the like.

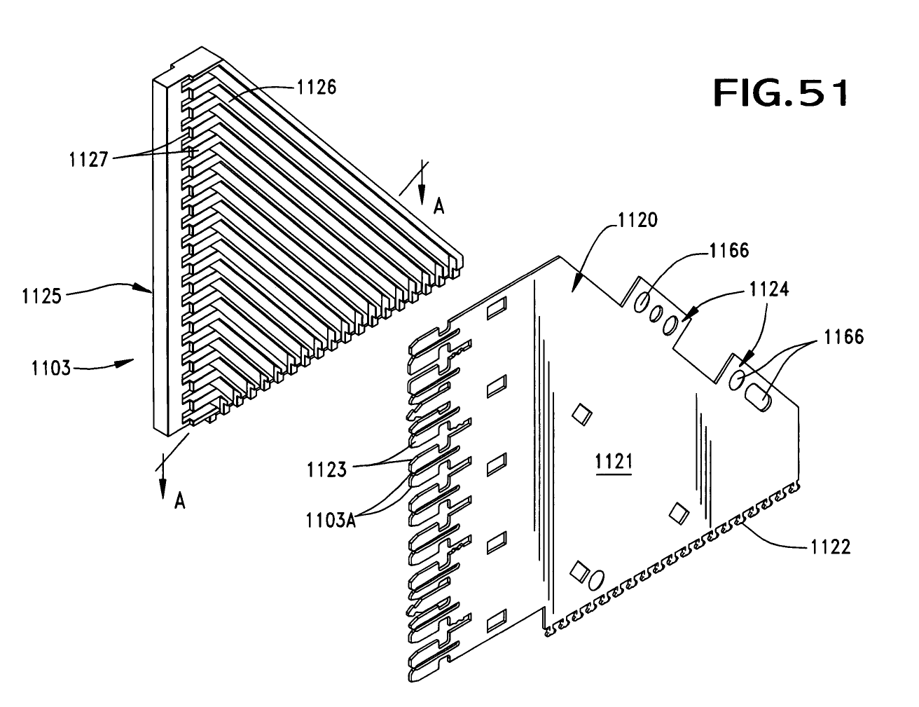

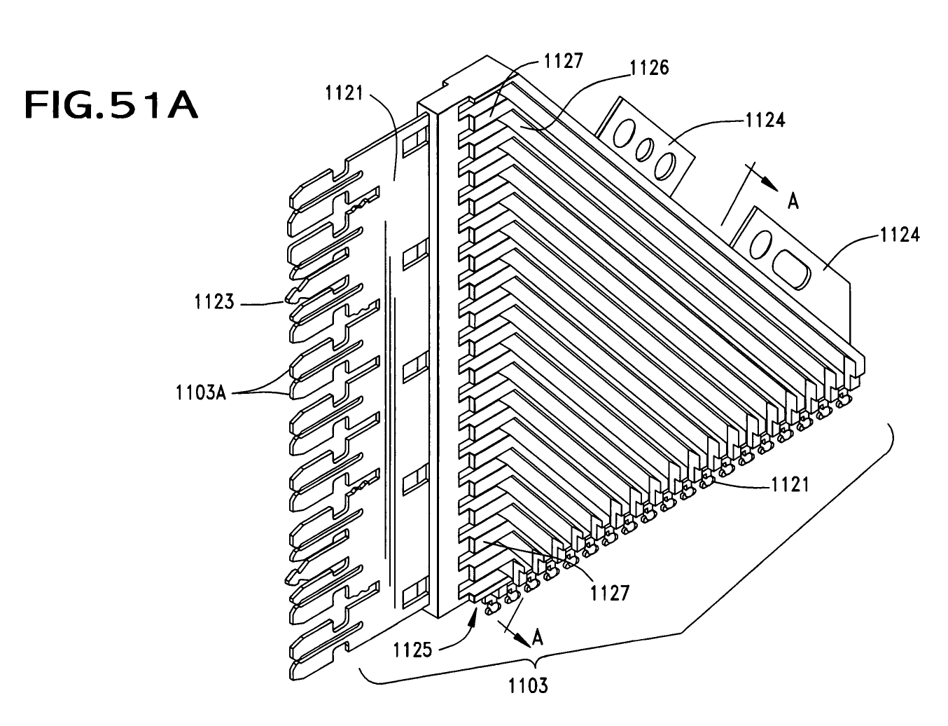

n an important aspect of the present invention, and as shown in FIG. 51, the central ground terminal support member 1103 includes a conductive central ground plate 1120 with tail portions 1122 and contact portions 1103A, 1123 formed on different edges thereof. The contact portions 1103A are slotted beam contacts and are oriented at a 90 degree offset to the contact blades 1221 of the ground terminal set 1208 of the receptacle connector 1204, while occasional other contact portions 1123 are provided. In this manner, a cross or cruciform pattern is formed in the mating regions of the contacts of the two connectors 1000, 1200 similar to that described with reference to the connector terminal assemblies depicted in FIGS. 31 and 32, i.e., the contact portions 1123 of the central ground member 1103 of each plug connector terminal assembly 1100 engage the receptacle connector center ground terminal array contact portions at an angle, or transversely to the array of such terminals. The end result of this mating is to provide a shielding array or “box” around substantially each signal terminal of the connector assembly through the mating interface thereof as well as substantially along the extent of the terminals of the two mating connectors from circuit board to circuit board.

The central ground plate 1120 has a planar body portion 1121 (FIG. 48A) with one or more retention tabs 1124 formed thereon along one edge, preferably a rear or trailing edge thereof. The plate 1120 includes tail portions 1122 and contact portions 1103A, 1123 extending out from it along different sides. This ground plate 1120 is enclosed within a dielectric housing, or shell, 1125 that is preferably formed from a moldable material such as a plastic, and is formed with a plurality of channels, or valleys 1126 flanked by raised lands 1127 to create in effect a somewhat sawtooth arrangement on the opposing sides of the housing 1125. The ground member 1120 may be molded into the housing 1103 or it may be captured in another manner between two interengaging halves thereof (not shown). The exterior surface of this housing 1125 is preferably conductive and may be made conductive by way of plating the material from which it is made utilizing plated plastic technology. In this manner, as shown best in FIGS. 51 & 52, the actual metal ground member is surrounded with a dielectric material that is also plated on substantially all of its exterior surfaces to provide a shielding, or grounding, aspect to the entire ground member 1103. The conductive plating on the exterior surfaces of the central ground terminal support member contacts the central ground plate 1120 so that the central ground terminal support member acts as a single, unitary ground member.

The inner-facing, exterior faces 1160 of the signal terminal support members 1101, 1102 (FIG. 48) are also formed with a pattern of lands 1161 and valleys 1162 that are formed in a spacing and arrangement that is opposite that of the ground terminal support member 1120. This is so the signal terminal support members will

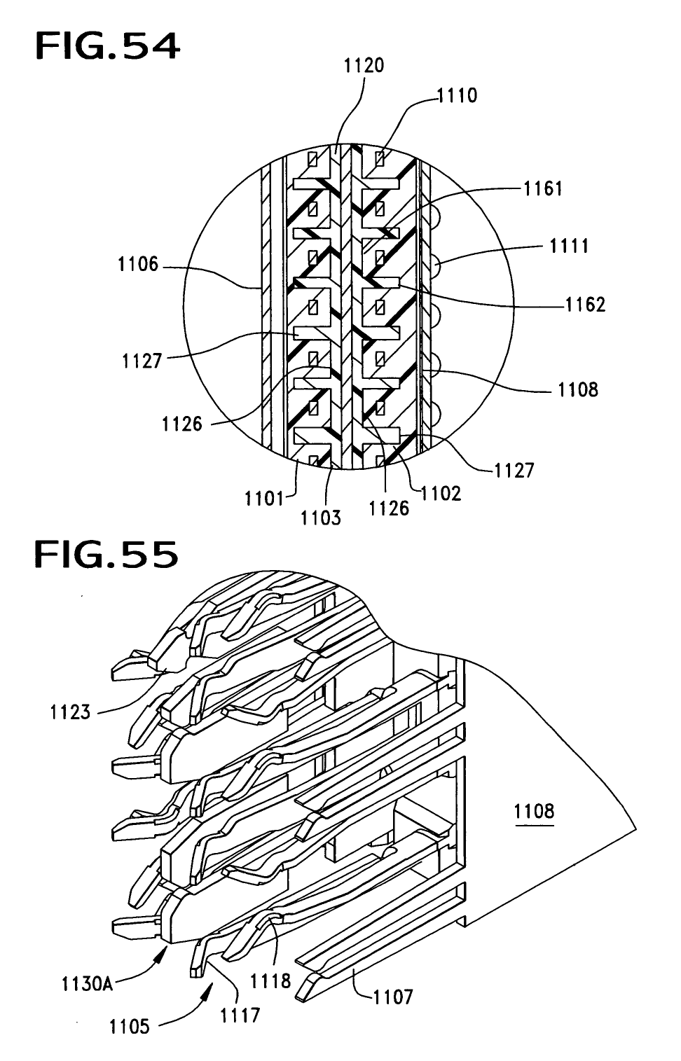

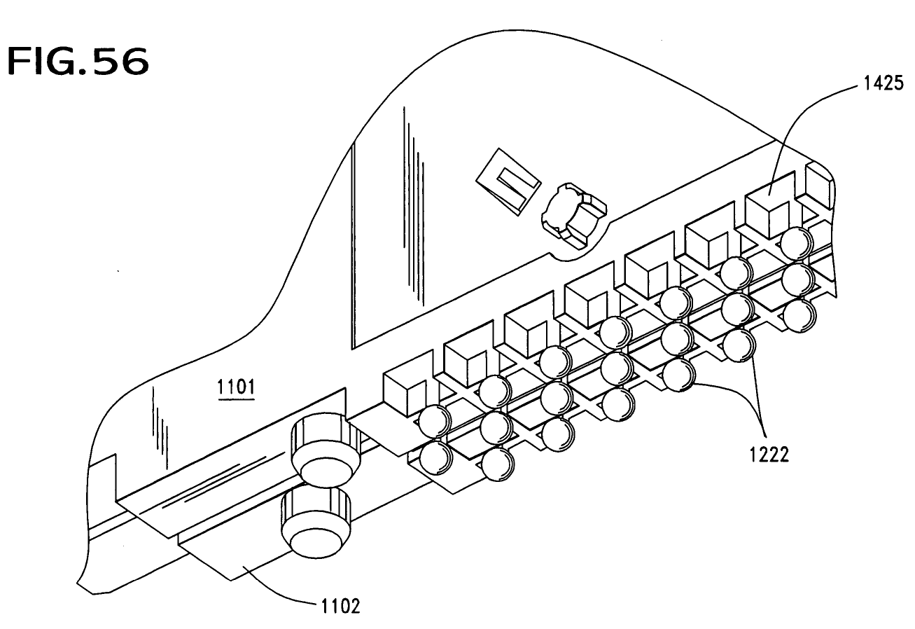

be received within the opposing complementary channels and lands of the central ground terminal support member 1120. Posts 1165 may be provided on the signal terminal support shells 1130 that fit through holes 1166 disposed in the retention tabs 1124 of the central shield body portion 1140 in order to hold the signal terminal members 1101, 1102 together and assist in clamping the central ground terminal support member 1103 therebetween. These posts and openings may be used to ultrasonically weld the entire terminal assembly 1100 together. In this manner, the plated surfaces of the center ground member serve to provide a ground reference along three sides of each signal terminal (in addition to the center ground member). This is shown in cross-section in FIG. 54. The plated portions of the central ground member define, in effect, three separate sides of a “shielding box” which may be considered as being closed by the exterior ground plates 1106, 1108, with one of the plates 1108 being held in a recess 1131, and the other of the two plates 1106 being slightly spaced apart from the edge of the wafer 1102, or both of the plates being held within recesses 1131 formed on the signal terminal support shells.

As shown best in FIG. 47A, the central ground terminal support member 1103 is held between, or “captured” entirely between its two flanking signal terminal support members 1101, 1102. In this manner, effective shielding is provided for the signal terminals in their extent through the plug connector terminal assembly 1101. This shielding permits the connectors of the invention to be used in high speed, single-ended signal transfer applications, not differential signal applications. Cavities 1425 may be formed in the terminal assemblies adjacent to the solder ball tail portions 1222. (FIG. 55.)

This spatial relationship encourages capacitive coupling between the signal terminals of each terminal assembly with their surround associated center ground, and discourages capacitive coupling between the signal terminals of one terminal assembly and the signal terminals of adjacent terminal assemblies, which would lead to crosstalk and noise during high-frequency data transmission.

While the preferred embodiment of the invention have been shown and described, it will be apparent to those skilled in the art that changes and modifications may be made therein without departing from the spirit of the invention, the scope of which is defined by the appended claims.

1. A high-density, high-speed connector for interconnecting two circuit boards together, the connector comprising:
a connector housing, a plurality of distinct sets of terminal assemblies supported within the connector housing, each of the terminal assemblies including a plurality of tail portions for connecting the terminals to a circuit board and a plurality of contact portions for contacting terminals of a mating connector, each of the distinct terminal sets including a central ground terminal support member and at least two signal terminal support members;
the central ground terminal support member including a central conductive ground plate with a plurality of contact portions extending therefrom, the central ground plate being encapsulated within an outer dielectric shell, the central ground terminal support member outer shell having a conductive coating disposed on its exterior surfaces which contacts the central ground plate;
each of the two signal terminal support members supporting an array of conductive signal terminals arranged in two arrays, each signal terminal of the array including a tail portion for connecting to a circuit board and a contact portion for connecting to the mating connector, and a body portion that interconnects the signal terminal tail and contact portions together, each of signal arrays being held within a respective outer dielectric shell, the signal terminal shells being disposed on opposite sides of said central ground terminal support member, each signal terminal shell including a plurality of raised lands separated by intervening channels disposed thereon, said body portions of said signal terminal arrays being encapsulated within said signal terminal support member raised lands; and,
each of said terminal assemblies further including a pair of outer ground plates disposed on exterior surfaces of the signal terminal shells and spaced apart from the central ground terminal support member and signal terminals, each of said outer ground plates including contact portions extend therefrom.

2. The connector of claim 1, wherein said central ground terminal support member conductive surfaces and the outer ground plates define a four-sided shielded channel that extends for lengths of said signal terminal array terminal body portions.

3. The connector of claim 1, wherein said and said central ground terminal support member also includes a plurality of channels and raised lands disposed on opposing sides thereof.

4. The connector of claim 3, wherein said each of said central ground terminal support member channels and raised lands extend in paths between two adjacent edges of said central ground terminal support member.

5. The connector of claim 3, wherein said signal terminal support member raised land are received within said central ground terminal support member channels and said signal terminal support member channels receive said central ground terminal support member raised lands.

6. The connector of claim 1, wherein said signal terminal array terminal tail portions include solder balls and wherein said signal terminal support shells include cavities formed along an edge thereof, each of the cavities being disposed adjacent to a single solder ball.

7. The connector of claim 1, wherein said connector housing includes a plurality of rails formed thereon within an interior of said connector housing, the rails defining a plurality of individual slots, each of the slots receiving a single terminal assembly therein.

8. The connector of claim 7, wherein said terminal assemblies include slots that are disposed along edges thereof, the slots receiving said connector housing rails.

9. The connector of claim 1, wherein said central ground terminal support member is captured between said two signal terminal support members such that only said central ground terminal plate tail and contact portions extend outwardly from said terminal assembly.

10. The connector of claim 1, wherein each of said signal terminal contact portions includes pairs of L-shaped contacts flanking a central ground terminal contact portion.

11. The connector of claim 1, wherein each of said plug connector terminal assemblies has said central ground terminal support member, signal terminal support members and ground plate contact portions arranged in a ground-signal-ground-signal-ground order.

12. A receptacle connector, comprising:
an outer hollow insulative housing defining an interior receptacle, the receptacle including a plurality of conductive signal and ground terminals arranged therein, the signal terminals being supported within said receptacle by an insulative support base and each of said signal terminals including a tail portion and a contact portion at opposing ends thereof, said signal terminals being spaced apart from each other along the insulative support base to define a linear array of signal terminals, said receptacle including at least two linear arrays of said signal terminals, the ground round terminals being arranged within said receptacle in at least first and second distinct linear arrays, the first ground terminal array including a conductive base portion and a plurality of contact and tail portions extending from opposite sides of the base portion and the second ground terminal array also including a conductive base portion and a plurality of contact and tail portions extending from opposite sides of the base portion, said signal terminal and said ground terminal first and second terminal arrays being arranged in alternating order of ground-signal-ground-signal terminals.

13. The receptacle connector of claim 12, wherein said contact portions of said first array of ground terminals are wider than said contact portions of said second array of ground terminals.

14. The receptacle connector of claim 13, wherein said contact portions of said first and second arrays of ground terminals are aligned with each other in directions transverse to said linear terminal arrays.

15. The receptacle connector of claim 12, wherein each of said signal terminal contact portions includes an L-shaped contact portion.

16. The receptacle connector of claim 12, wherein said signal terminal tail portions include solder balls.

17. A high-density, high-speed connector assembly for interconnecting two circuit boards together, the connector comprising:
interengaging plug and receptacle connectors;
the plug connector including an insulative connector housing, a plurality of distinct sets of terminal assemblies supported within the connector housing, each of the terminal assemblies including a plurality of tail portions for connecting the terminals to a circuit board and a plurality of contact portions for contacting terminals of a mating connector, each of the distinct terminal sets including a central ground terminal support member and at least two signal terminal support members;
the central ground terminal support member including a central conductive ground plate with a plurality of contact portions extending therefrom, the central ground plate being encapsulated within an outer dielectric shell, the central ground terminal support member outer shell having a conductive coating disposed on its exterior surfaces which contacts the central ground plate;
each of the two signal terminal support members supporting an array of conductive signal terminals arranged in two arrays, each signal terminal of the array including a tail portion for connecting to a circuit board and a contact portion for connecting to the mating connector, and a body portion that interconnects the signal terminal tail and contact portions together, each of signal arrays being held within a respective outer dielectric shell, the signal terminal shells being disposed on opposite sides of said central ground terminal support member, each signal terminal shell including a plurality of raised lands separated by intervening channels disposed thereon, said body portions of said signal terminal arrays being encapsulated within said signal terminal support member raised lands;
each of said terminal assemblies further including a pair of outer ground plates disposed on exterior surfaces of the signal terminal shells and spaced apart from the central ground terminal support member and signal terminals, each of said outer ground plates including contact portions extending therefrom, said central ground terminal support member, signal terminal support members and ground plate contact portions being arranged in said plug connector housing to define an alternating order of ground-signal-ground-signal-ground terminals;
the receptacle connector including an outer hollow insulative housing defining an interior receptacle, the receptacle including a plurality of conductive signal and ground terminals arranged therein, the signal terminals being supported within said receptacle by an insulative support base and each of said signal terminals including a tail portion and a contact portion at opposing ends thereof, said signal terminals being spaced apart from each other along the insulative support base to define a linear array of signal terminals, said receptacle including at least two linear arrays of said signal terminals, the ground round terminals being arranged within said receptacle in at least first and second distinct linear arrays, the first ground terminal array including a conductive base portion and a plurality of contact and tail portions extending from opposite sides of the base portion and the second ground terminal array also including a conductive base portion and a plurality of contact and tail portions extending from opposite sides of the base portion, said signal terminal and said ground terminal first and second terminal arrays being arranged in alternating order of ground-signal-ground-signal-ground terminals.

18. The connector assembly of claim 17, wherein said receptacle connector linear terminal arrays are arranged transversely to said plug connector terminal assemblies.
